(19) United States
(12) Patent Application Publication
(10) Pub. No.: US 2006/0087173 A1
(43) Pub. Date: Apr. 27, 2006

(54) Brake control system

(75) Inventors: Keigo Kajiyama, Kanagawa (JP); Chiharu Nakazawa, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD.

(21) Appl. No.: 11/226,311

(22) Filed: Sep. 15, 2005

(30) Foreign Application Priority Data
Jul. 19, 2005 (JP) 2005-208046
Sep. 15, 2004 (JP) 2004-268834

(51) Int. Cl. B60T 13/74

(52) U.S. Cl. 303/3; 303/115.1

(57) ABSTRACT

In a brake control system for a vehicle employing a brake-by-wire (BBW) hydraulic control unit, a master cylinder serves as a first fluid pressure source and a pump serves as a second fluid pressure source operated during a BBW system normal brake operating mode. Also provided is a manual-brake hydraulic circuit capable of supplying hydraulic pressure from the master cylinder to the wheel-brake cylinder during a fail-safe operating mode. A back-flow prevention device is disposed in a pump outlet passage, intercommunicating the manual-brake hydraulic circuit and the pump outlet, for permitting free flow in one direction from the pump to the wheel cylinder. A normally-open inflow valve is disposed in the pump outlet passage downstream of the back-flow prevention device. A normally-open shutoff valve is disposed in the manual-brake hydraulic circuit upstream of the normally-open inflow valve, and unactuated and opened during the fail-safe operating mode.

### TECHNICAL FIELD

The present invention relates to a brake control system for automotive vehicles, and specifically to an accumulatorless hydraulic brake control system of less wasteful energy consumption.

### BACKGROUND ART

As is generally known, on automotive brake systems used to control braking torque (negative wheel torque) or wheel-brake cylinder pressure, it is more desirable to enhance a braking response to a demand for braking and also to provide an enhanced vehicle dynamics control performance or a stable vehicle dynamic behavior achieved by hydraulic brake control. On typical hydraulic brake systems, a pressure accumulator is often used to temporarily accumulate hydraulic pressure therein. The hydraulic pressure in the accumulator is fed or supplied to wheel-brake cylinders to operate the brakes of the automotive vehicle. One such pressure-accumulator equipped hydraulic brake system has been disclosed in Japanese Patent Provisional Publication No. 2000-168536 (hereinafter is referred to as “JP2000-168536”). With the arrangement as disclosed in JP2000-168536, it is possible to quickly deliver the brake-fluid pressure, having a hydraulic pressure level required during normal braking, to each of wheel-brake cylinders, by setting the brake-fluid pressure in the accumulator to as high a pressure level as possible.

However, in such brake control systems employing a pressure accumulator of a comparatively high accumulator set pressure when brake-fluid pressure is delivered to a wheel-brake cylinder by opening a control valve connected to the wheel-cylinder inlet-and-outlet port, the comparatively high brake-fluid pressure, which is temporarily stored in the accumulator and ensures a high braking response, acts on the wheel cylinder. There is an increased tendency for the flow rate of brake fluid in the wheel-brake cylinder subjected to brake control to overshoot a desired value, in other words, there is a tendency for a rapid change in the flow rate of brake fluid supplied into the wheel cylinder to occur owing to the comparatively high accumulator set pressure. Such a rapid brake-fluid flow rate change would be likely to cause the driver to feel considerable discomfort (that is, unnatural brake feeling). Additionally, in order to ensure the good brake control responsiveness, the pressure accumulator requires a comparatively large accumulating capacity. Such a large accumulating-capacity accumulator has almost the same size as a motor installed on the vehicle for driving a pump, serving as a hydraulic pressure source. This leads to a problem of large-sizing and increased weight of the brake system, thus deteriorating the mountability of the system on the automotive vehicle. To avoid this, in recent years, there have been proposed and developed various accumulatorless hydraulic brake control systems. One such accumulatorless hydraulic brake control system has been disclosed in Japanese Patent Provisional Publication No. 2000-159094 (hereinafter is referred to as “JP2000-15094”). Such an accumulatorless hydraulic brake system is superior in reduced energy consumption, easy mounting, lightening, and downsizing of the system. It would be desirable to provide an accumulatorless hydraulic brake control system having a more stable brake performance.

### SUMMARY OF THE INVENTION

Accordingly, it is an object of the invention to provide an accumulatorless hydraulic brake control system capable of ensuring a more stable brake performance, reduced energy consumption, easy mounting, lightening, and downsizing of the system.

In order to accomplish the aforementioned and other objects of the present invention, a brake control system comprises a first fluid pressure source comprising a master cylinder, a second fluid pressure source provided separately from the master cylinder, for supplying hydraulic pressure from the second fluid pressure source to at least one wheel-brake cylinder during a brake operating mode, the second fluid pressure source comprising a pump, a manual-brake hydraulic circuit capable of supplying hydraulic pressure from the master cylinder to the wheel-brake cylinder during a fail-safe operating mode, a pump outlet passage that interconnects the pump and the manual-brake hydraulic circuit, for introducing brake fluid discharged from the pump into the manual-brake hydraulic circuit, a back-flow prevention-device disposed in the pump outlet passage, for permitting free brake-fluid flow in one direction from the pump to the wheel-brake cylinder and for preventing any brake fluid flow in the opposite direction, a normally-open inflow valve disposed in the pump outlet passage and located between the back-flow prevention device and the manual-brake hydraulic circuit, for establishing fluid communication between the manual-brake hydraulic circuit and the pump outlet passage with the normally-open inflow valve unactuated and opened, and a normally-open shutoff valve disposed in the manual-brake hydraulic circuit, for establishing fluid communication between the master cylinder and the wheel-brake cylinder through the manual-brake hydraulic circuit with the normally-open shutoff valve unactuated and opened during the fail-safe operating mode, the normally-open shutoff valve being disposed in the manual-brake hydraulic circuit upstream of the normally-open inflow valve.

According to another aspect of the invention, a brake control system comprises a first fluid pressure source comprising a master cylinder, a second fluid pressure source provided separately from the master cylinder, for supplying hydraulic pressure from the second fluid pressure source to at least one wheel-brake cylinder during a brake operating mode, the second fluid pressure source comprising a pump, a manual-brake hydraulic circuit capable of supplying hydraulic pressure from the master cylinder to the wheel-brake cylinder during a fail-safe operating mode, a pump outlet passage that interconnects the pump and the manual-brake hydraulic circuit, for introducing brake fluid discharged from the pump into the manual-brake hydraulic circuit, a normally-closed inflow valve disposed in the pump outlet passage, for blocking fluid communication between the manual-brake hydraulic circuit and the pump outlet passage with the normally-closed inflow valve unactuated and closed, and a normally-open shutoff valve disposed in the manual-brake hydraulic circuit, for establishing fluid communication between the master cylinder and the wheel-brake cylinder through the manual-brake hydraulic circuit with the normally-open shutoff valve unactuated and opened during the fail-safe operating mode, the normally-open shutoff valve being disposed in the manual-brake hydraulic circuit upstream of the normally-closed inflow valve.

According to a further aspect of the invention, a brake control system comprises a first fluid pressure source comprising a master cylinder, a second fluid pressure source provided separately from the master cylinder, for supplying hydraulic pressure from the second fluid pressure source to at least one wheel-brake cylinder during a brake operating mode, the second fluid pressure source comprising a pump, a manual-brake hydraulic circuit capable of supplying hydraulic pressure from the master cylinder to the wheel-brake cylinder during a fail-safe operating mode, a pump outlet passage that interconnects the pump and the manual-brake hydraulic circuit, for introducing brake fluid discharged from the pump into the manual-brake hydraulic circuit, back-flow prevention means disposed in the pump outlet passage, for permitting free brake-fluid flow in one direction from the pump to the wheel-brake cylinder and for preventing any brake fluid flow in the opposite direction, normally-open inflow valve means disposed in the pump outlet passage and located between the back-flow prevention means and the manual-brake hydraulic circuit, for establishing fluid communication between the manual-brake hydraulic circuit and the pump outlet passage with the normally-open inflow valve means unactuated and opened, and normally-open shutoff valve means disposed in the manual-brake hydraulic circuit, for establishing fluid communication between the master cylinder and the wheel-brake cylinder through the manual-brake hydraulic circuit with the normally-open shutoff valve means unactuated and opened during the fail-safe operating mode, the normally-open shutoff valve means being disposed in the manual-brake hydraulic circuit upstream of the normally-open inflow valve means.

The other objects and features of this invention will become understood from the following description with reference to the accompanying drawings.

### BRIEF DESCRIPTION OF THE DRAWINGS

FIG. 1 is a hydraulic circuit diagram showing a front-wheel brake-by-wire (BBW) hydraulic pressure control unit to which an accumulatorless hydraulic brake control system of the first embodiment is applied.

FIG. 2 is a simplified hydraulic circuit diagram showing an earlier ABS-VDC control system with braking system interaction.

FIG. 3 is a simplified hydraulic circuit diagram showing the accumulatorless brake control system of the first embodiment.

FIG. 4 is a characteristic diagram showing two different brake-depression-force versus wheel-brake cylinder pressure characteristic curves, respectively obtained by the accumulatorless brake control system (see FIG. 3) of the first embodiment and the earlier ABS-VDC control system (see FIG. 2).

FIG. 5 is a hydraulic circuit diagram showing a four-wheel BBW hydraulic pressure control unit to which an accumulatorless hydraulic brake control system of the second embodiment is applied.

FIG. 6 is a hydraulic circuit diagram showing a front-wheel BBW hydraulic pressure control unit to which an accumulatorless hydraulic brake control system of the third embodiment is applied.

FIG. 7 is a hydraulic circuit diagram showing a front-wheel BBW hydraulic pressure control unit to which an accumulatorless hydraulic brake control system of the fourth embodiment is applied.

FIG. 8 is a cross-sectional view showing the detailed structure of a pair of check valves applicable to the BBW hydraulic pressure control unit, in the case that the brake control system uses a tandem plunger pump (see FIG. 6) as a hydraulic pressure source for BBW control.

FIG. 9 is a cross-sectional view showing the detailed structure of another type of check valves applicable to the BBW hydraulic pressure control unit, in the case that the brake control system uses an external gear pump (See FIGS. 1, 5 and 7) as a hydraulic pressure source for-BBW control.

FIG. 10 is a lateral cross-sectional view showing the detailed structure of a trochoid pump (an internal gear pump) applicable to the BBW hydraulic pressure control unit.

FIG. 11 is a control current versus solenoid valve attraction force characteristic curve.

### DESCRIPTION OF THE PREFERRED EMBODIMENTS

[Construction of Hydraulic Circuit of Brake Control System]

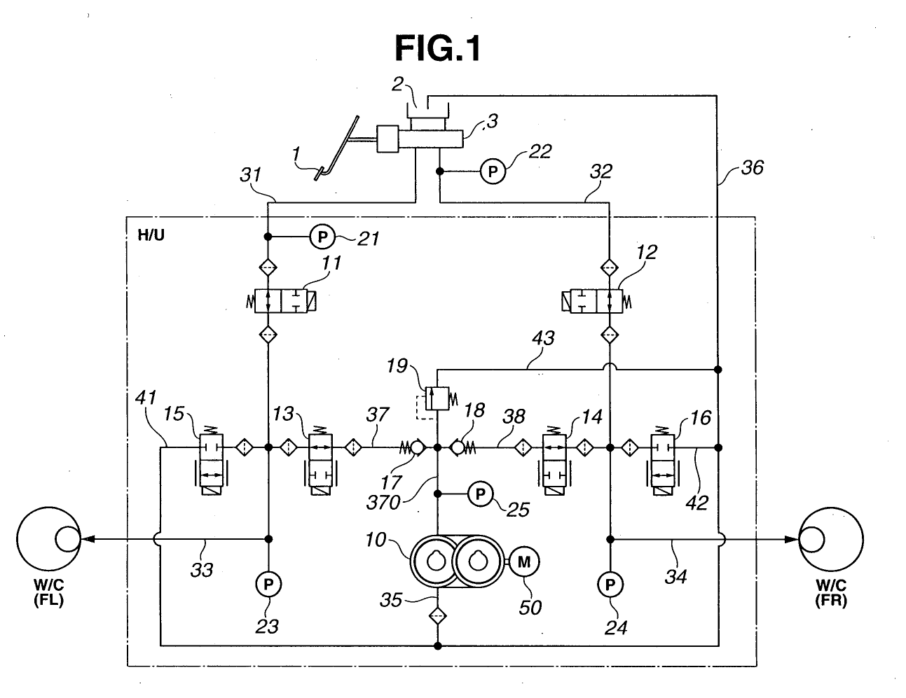

Referring now to the drawings, particularly to FIG. 1, the accumulatorless hydraulic brake control system of the first embodiment is exemplified in an automotive vehicle employing a front-wheel brake-by-wire (BBW) hydraulic pressure control unit. As clearly shown in FIG. 1, a master cylinder 3 is constructed by a dual-brake system master cylinder (a tandem master cylinder with two pistons in tandem). That is, a so-called dual circuit brake system is used. Master-cylinder pressure can be delivered individually to each of two different brake line systems, namely a P hydraulic circuit having a first fluid line (a first manual-brake fluid line) 31 via which brake fluid is supplied from the master cylinder to a front-left wheel-brake cylinder W/C(FL), and an S hydraulic circuit having a second fluid line (a second manual-brake fluid line) 32 via which brake fluid is supplied from the master cylinder to a front-right wheel-brake cylinder W/C(FR). A brake-fluid reservoir 2 is installed on master cylinder 3 for storage of brake fluid.

The brake control system of the first embodiment includes the front-wheel BBW hydraulic pressure control unit in which pressure supply to each of front-left and front-right wheel-brake cylinders W/C(FL) and W/C(FR) can be performed by means of a pump 10 having a driven connection with an electronically-controlled motor (simply, a motor) 50. During a fail-safe operating mode, master-cylinder pressure can be delivered directly into front-left wheel-brake cylinder W/C(FL) through the first fluid line 31 and a first fail-safe fluid line 33, and simultaneously delivered into front-right wheel-brake cylinder W/C(FR) through the second fluid line 32 and a second fail-safe fluid line 34. In the BBW hydraulic pressure control system, in order to ensure a stroke of a brake pedal 1 during a BBW system normal brake operating mode, a stroke simulator and a stroke sensor are provided close to the master cylinder. For instance, at least one stroke simulator is located between brake pedal 1 and master cylinder 3. The stroke simulator (or the feedback brake-pedal-depression reaction force simulator) functions to create and apply a braking reaction force (a feedback pedal-depression reaction force) to brake pedal 1 during the BBW system normal brake operating mode. The applied reaction force created by means of the stroke simulator during the BBW system normal brake operating mode, is important to give the driver a brake feel substantially similar to a feel of the braking action during the driver's brake pedal stroke, taken in by the driver through brake pedal 1 during manual braking. The driver's brake-pedal depression amount is detected by means of the brake-pedal stroke sensor, located near master cylinder 3. Pump 10 is driven or-operated responsively to the driver's brake-pedal depression amount, detected by the brake-pedal stroke sensor, so that the actual wheel-brake cylinder pressure of each of wheel-brake cylinders W/C(F/L) and W/C(F/L) is brought closer to a desired wheel cylinder pressure value determined based on the detected driver's brake-pedal depression amount (the detected brake-pedal stroke). In the system of the first embodiment shown in FIG. 1, in order to ensure the desired wheel cylinder pressure with less brake-fluid pulsations (with less variations in the quantity of brake fluid discharged from pump 10) and also to ensure a continuous brake-fluid discharge greater than a designated constant flow rate, pump 10 is comprised of a gear pump (exactly, an external gear pump). In the shown embodiment, a brushless motor is used as motor 50.

As can be seen from the hydraulic circuit diagram of FIG. 1, a normally-open shutoff valve 11 is disposed in fluid line 31 via which front-left wheel-brake cylinder W/C(FL) is connected to the first port of master cylinder 3. In a similar manner, a normally-open shutoff valve 12 is disposed in fluid line 32 via which front-right wheel-brake cylinder W/C(FR) is connected to the second port of master cylinder 3. During the BBW system normal brake operating mode, the first normally-open shutoff valve 11, disposed in fluid line 31 of the P hydraulic circuit, and the second normally-open shutoff valve 12, disposed in fluid line 32 of the S hydraulic circuit, are both closed and held at their shutoff states. On the contrary, during the fail-safe operating mode, the first and second normally-open shutoff valves 11 and 12 are both opened and held at their fully-open states. Each of shutoff valves 11 and 12 is comprised of a normally-open, two-port two-position, electromagnetic shutoff valve. Therefore, even if the electric system failure occurs, these shutoff valves 11-12 are automatically held at their fully-opened positions for failsafe purposes, and whereby it is possible to produce manual braking action based on the master-cylinder pressure, whose pressure value is determined by the driver's brake-pedal depression force. A first fluid pressure sensor 21 is connected to or located on the first fluid line 31 between the first port of master cylinder 3 and the first shutoff valve 11. A second fluid pressure sensor 22 is connected to or located on the second fluid line 32 between the second port of master cylinder 3 and the second shutoff valve 12. A third fluid pressure sensor 23 is connected to or located on the first fail-safe fluid line 33. A fourth fluid pressure sensor 24 is connected to or located on the second fail-safe fluid line 34. The hydraulic circuit surrounded by the one-dotted line in FIG. 1, indicates a hydraulic pressure control unit (H/U) or a hydraulic control module. As can be seen from the hydraulic circuit diagram of FIG. 1, as a countermeasure for the system failure, only the second fluid pressure sensor 22 is connected to the fluid line of the master-cylinder side, whereas the other fluid pressure sensors 21, 23, and 24 are connected to the respective fluid lines defined in the hydraulic pressure control unit (H/U). That is, the other fluid pressure sensors 21, 23, and 24 are compactly built in the hydraulic pressure control unit (H/U). Actually, for the purpose of lower system installation time and costs, reduced oil leakage and contamination due to fewer fittings, reduce service time, smaller space requirements of overall hydraulic system, brake circuits, check valves, and/or electromagnetic valves are integrated as a single hydraulic control system block (or an integrated hydraulic control module). In FIG. 1, pump 10 is disposed between a pump inlet fluid line denoted by reference sign 35 and a pump outlet fluid line (or a pump discharge fluid line) denoted by reference sign 370. Pump inlet fluid line 35 is connected via a fluid line 36 to reservoir 2. Pump discharge fluid line 370 is connected to a fluid line 43 via a check valve (or a pressure relief valve) 19. Pump discharge fluid line 370 is also connected via a first one-way check valve 17, serving as a back-flow control device or a back-flow prevention device (or a back-flow preventing means), to one end of a fluid line (or a pump outlet passage) 37. Additionally, pump discharge fluid line 370 is connected via a second one-way check valve 18, serving as back-flow preventing means, to one end of a fluid line (or a pump outlet passage) 38. A fluid pressure sensor 25 is connected to or disposed in pump discharge fluid line 370. The other end of fluid line 37 is connected to a fluid-line section of the first fluid line 31 between the first shutoff valve 11 and the first fail-safe fluid line 33. In a similar manner, the other end of fluid line 38 is connected to a fluid-line section of the second fluid line 32 between the second shutoff valve 12 and the second fail-safe fluid line 34. In the hydraulic circuit extending from the pump discharge passage side to the first fluid line 31, the one-way check valve 17 and an inflow valve (or an inlet valve) 13 are disposed in that order. In the hydraulic circuit extending from the pump discharge passage side to the second fluid line 32, the one-way check valve 18 and an inflow valve (or an inlet valve) 14 are disposed in that order. In the shown embodiment, each of inflow valves 13 and 14 is comprised of a normally-open, two-port two-position, electromagnetic proportional control valve. Additionally, the first fluid line 31 is branched at a branched point (that is, at the connecting point between the other end of fluid line 37 and the first fluid line 31) into the first fail-safe fluid line 33 and a first branch fluid line 41. Additionally, the second fluid line 32 is branched at a branched point (that is, at the connecting point between the other end of fluid line 38 and the second fluid line 32) into the second fail-safe fluid line 34 and a second branch fluid line 42. Branch fluid lines 41 and 42 are both connected to fluid line 36. An outflow valve (or an outlet valve) 15 is disposed in the first branch fluid line 41, whereas an outflow valve (or an outlet valve) 16 is disposed in the second branch fluid line 42. In the shown embodiment, each of outflow valves 15 and 16 is comprised of a normally-closed, two-port two-position, electromagnetic proportional control valve. As discussed previously, check valve (pressure relief valve) 19 is disposed in fluid line 43. When the fluid pressure in the discharge passage side of pump 10 exceeds a set pressure value of relief valve 19, relief valve 19 is shifted to a valve open state so as to relieve fluid pressure beyond the set pressure value, and return part of pressurized brake fluid through the relief valve to the reservoir. With the previously-noted arrangement, the manual-brake hydraulic circuit (or the manual-brake hydraulic line) containing fluid lines 31 and 33 is connected to the hydraulic circuit interconnecting the first check valve 17 and front-left wheel-brake cylinder W/C(FL). In a similar manner, the manual-brake hydraulic circuit (or the manual-brake hydraulic line) containing fluid lines 32 and 34 is connected to the hydraulic circuit interconnecting the second check valve 18 and front-right wheel-brake cylinder W/C(FR).

[Best System Normal Operating Mode]

During the front-wheel (two-channel) brake-by-wire (BBW) system normal brake operating mode, the stroke of brake pedal 1 is detected by means of the stroke sensor, located near master cylinder 3. Pump 10 is driven responsively to the driver's brake-pedal depression amount (the brake-pedal stroke) detected by the stroke sensor, so that the actual wheel-brake cylinder pressure of each of wheel-brake cylinders W/C(F/L) and W/C(F/L) is brought closer to a desired wheel cylinder pressure value determined based on the detected brake-pedal stroke in accordance with brake-by-wire (BBW) control. During the BBW system normal brake operating mode, in order to prevent master-cylinder pressure from being delivered into each of front-left and front-right wheel-brake cylinders w/C(FL) and W/C(FR), two shutoff valves 11-12 are both closed and held at their shutoff states so as to block or shut off fluid communication between the first port of master cylinder 3 and front-left wheel-brake cylinder W/C(FL) and simultaneously block or shut off fluid communication between the second port of master cylinder 3 and front-right wheel-brake cylinder W/C(FR).

<During Wheel-Cylinder Pressure Build-Up Operating Mode>

During pressure buildup at the BBW system normal brake operating mode, two shutoff valves 11-12 are held at their shutoff states (at energized or actuated states) and pump 10 is operated by motor 50, such that brake fluid in reservoir 2 is inducted through fluid line 36 via fluid line 35 into the inlet port of pump 10. At:this time, inflow valves 13-14 are held at their normally-opened states (at de-energized or unactuated states), and outflow valves 15-16 are held at their normally-closed states (at de-energized or unactuated states). Thus, brake fluid pressurized by pump 10 is delivered through fluid line 37 and fail-safe fluid line 33 into front-left wheel-brake cylinder W/C(FL), and simultaneously the pressurized brake fluid is delivered through fluid line 38 and fail-safe fluid line 34 into front-right wheel-brake cylinder W/C(FR), for wheel-cylinder pressure build-up. When the fluid pressure in the discharge side of pump 10 exceeds the set pressure of relief valve 19, relief valve 19 is opened to relieve surplus pressure beyond the set pressure and to return part of pressurized brake fluid to reservoir 2, for fail-safe purposes of the pressured system.

<During Wheel-Cylinder Pressure Hold Operating Mode>

During pressure hold at the BBW system normal brake operating mode, shutoff valves 11-12 are kept at their shutoff states (at energized states) and outflow valves 15-16 are kept at their closed states (at de-energized states), while inflow valves 13-14 are shifted to their closed states (to energized states) for wheel-cylinder pressure hold. When the pressure hold mode is maintained for a time period longer than a specified constant time period, motor 50 and pump 10 are both shifted to their inoperative states, and a pressure-relief time, during which the surplus pressure produced by pump 10 is relieved via relief valve 19 and brake fluid discharged from pump 10 flows through relief valve 19 into reservoir 2, can be effectively reduced or shortened, thus enhancing the energy efficiency. This contributes to a reduced fuel consumption rate.

<During Wheel-Cylinder Pressure Reduction Operating Mode>

During pressure reduction at the BBW system normal brake operating mode, shutoff valves 11-12 are held at their shutoff states (at energized states) and inflow valves 13-14 are kept at their closed states (at energized states), while outflow valves 15-16 are opened in accordance with proportional control. Thus, wheel-cylinder pressure in front-left wheel-brake cylinder W/C(FL) is relieved and pressure-reduced, and part of brake fluid in front-left wheel-brake cylinder W/C(FL) is returned through fail-safe fluid line 33, outflow-valve 15 opened, branch fluid line 41, and fluid line 36 to reservoir 2. Simultaneously, wheel-cylinder pressure in front-right wheel-brake cylinder W/C(FR) is relieved and pressure-reduced, and part of brake fluid in front-right wheel-brake cylinder W/C(FR) is returned through fail-safe fluid line 34, outflow valve 16 opened, branch fluid line 42, and fluid line 36 to reservoir 2. When a holding time, during which inflow valves 13-14 are held at their closed states (at energized states), exceeds a specified constant time period, in the same manner as the pressure-hold operating mode, motor 50 and pump 10 are shifted to their inoperative states (stopped states). This contributes to a reduction in driving time of motor 50.

[Fail-Safe Operating Mode]

When a system failure, such as a failure in motor 50, a failure in pump 10, and/or an-electric system failure, occurs, shutoff valves 11-12 are held at their fully-opened positions (at de-energized states). With shutoff valves 11-12 fully opened, master-cylinder pressure is applied directly into front-left wheel-brake cylinder w/C(FL) through the first fluid line 31 and the first fail-safe fluid line 33, and simultaneously applied directly into front-right wheel-brake cylinder w/c(FR) through the second fluid line 32 and the second fail-safe fluid line 34, such that a braking force is created by way of manual braking action. During the fail-safe operating mode (in the presence of the system failure), shutoff valves 11-12 can be automatically held at their fully-opened positions (at de-energized states), since shutoff valves 11-12 are comprised of normally-open electromagnetic shutoff valves. Thus, during the fail-safe operating mode, it is possible to insure or produce manual braking action based on the driver's brake pedal depression.

As can be seen -from the symmetrical hydraulic circuit shown in FIG. 1, the first brake circuit for front-left wheel-brake cylinder pressure control and the second brake circuit for front-right wheel-brake cylinder pressure control are symmetric to each other. In the system of the embodiment, the electromagnetic valve set (11, 13, 15) included in the first brake circuit and the electromagnetic valve set (12, 14, 16) included in the second brake circuit are simultaneously controlled. In lieu thereof, the electromagnetic valve set (11, 13, 15) included in the first brake circuit and the electromagnetic valve set (12, 14, 16) included in the second brake circuit may be controlled independently of each other. In such a case (according to front-left and front-right wheel-cylinder pressure independent control), it is possible to hold or reduce the front-right wheel cylinder pressure, while building-up the front-left wheel cylinder pressure. Alternatively, when simultaneously pressure-building up (or when simultaneously pressure-reducing) the front-left and front-right wheel cylinder pressures, the pressure build-up rate (or the pressure reduction rate) of front-left wheel cylinder W/C(FL) may differ from that of front-right wheel cylinder W/C(FR). The intended difference between the pressure build-up rate (or the pressure reduction rate) of front-left wheel cylinder W/C(FL) and the pressure build-up rate (or the pressure reduction rate) of front-right wheel cylinder W/C(FR) is suited to vehicle dynamics control performed by a vehicle dynamics control (VDC) system with braking system interaction.

[Action of Each of Valves Built in BBW Hydraulic Unit]

Check valve 17 disposed in fluid line 37 and check valve 18 disposed in fluid line 38 serve for permitting free brake-fluid flow in one fluid-flow direction from the pump discharge port to each of fluid lines 37-38, and for preventing back flow from fluid lines 37-38 to the pump discharge port (pump discharge fluid line 370). During the BBW system normal brake operating mode, when the discharge pressure of pump 10 (the fluid pressure in pump discharge fluid line 370) overcomes the spring force of each of check valves 17-18, check valves 17-18 are kept opened. During the fail-safe operating mode, check valves 17-18 serve to prevent back flow from the first and second ports of master cylinder 3 via fluid lines 37-38 to the pump discharge port (pump discharge fluid line 370). Therefore, during the fail-safe operating mode, it is possible to avoid brake fluid flow back to pump 10 by two check valves 17-18 rather than the electromagnetic valves.

In the system of the embodiment, each of inflow valve 13, disposed between check valve 17 and front-left wheel-brake cylinder W/C(FL), and inflow valve 14, disposed between check valve 18 and front-right wheel-brake cylinder W/C(FR), is comprised of a normally-open electromagnetic valve. Thus, during the BBW system normal brake operating mode, at which wheel-cylinder pressure control for each of front-left and front-right wheel-brake cylinders W/C(FL) and WC(FR) is achieved by pump 10, serving as a fluid pressure source for each individual wheel-brake cylinder, it is unnecessary to energize two inflow-valves (normally-open electromagnetic valves) 13-14. This contributes to a reduced electric power consumption.

Additionally, each of inflow valves 13-14 is comprised of a normally-open, electromagnetic proportional control valve. The proportional control valve is superior in valve-control accuracy, as compared to an ON/OFF control valve. For this reason, inflow valves 13-14, constructed by the normally-open, electromagnetic proportional control valves, are basically kept in their de-energized states during the BBW system normal brake operating mode. Only when the wheel-cylinder pressures in front wheel-brake cylinders W/C(FL) and W/C(FR) have to be finely controlled, inflow valves 13-14 are shifted to their energized states, thus reducing the energizing time of each of inflow valves 13-14, and consequently ensuring reduced electric power consumption. Even when there is a difference of fluid-flow resistance between the left-hand hydraulic circuit associated with front-left wheel-brake cylinder W/C(FL) and the right-hand hydraulic circuit associated with front-right wheel-brake cylinder W/C(FR)) because of each hydraulic-circuit's individual operating characteristics, it is possible to finely adjust the magnitude of braking force applied to the front-left wheel brake and the magnitude of braking force applied to the front-right wheel brake independently of each other by electronically controlling inflow valves 13-14, constructed by high-precision proportional control valves. If necessary, it is possible to equalize the wheel-cylinder pressure applied to front-left wheel-brake cylinder W/C(FL) and the wheel-cylinder pressure applied to front-right wheel-brake cylinder W/C(FR) by controlling inflow valves 13-14 independently of each other.

As discussed above, as inflow valves 13-14, the system of the embodiment uses proportional control valves rather than ON/OFF control valves. As is generally known, the ON/OFF control valve is designed to establish and block a hydraulic circuit by way of ON/OFF control. Each time switching between ON and OFF states occurs, the sliding spool of the ON/OFF control valve is brought into collision-contact with the inner peripheral wall of the valve housing (or the inner peripheral wall of the close-fitting bore defined in the valve body). This causes undesirable noise and vibration. In contrast, in case of proportional control valves, there is a decreased tendency for the sliding spool to be brought into collision-contact with the inner peripheral wall of the valve housing. That is, the proportional control valve, constructing each of inflow valves 13-14, is superior in reduced noise and vibration, in comparison with an ON/OFF control valve. As set forth above, as a countermeasure for the reduced noise and vibration during switching between de-energized and energized states of each of inflow valves 13-14, proportional control valves are used as inflow valves 13-14.

In addition to the above, the system of the embodiment uses the dual-brake system master cylinder (the tandem master cylinder. The first check valve (the left-hand side check valve in FIG. 1) 17 is disposed in fluid line 37 included in the left-hand hydraulic circuit in such a manner as to permit brake fluid flow in one fluid-flow direction from the pump discharge port via fluid line 37 toward front-left wheel-brake cylinder W/C(FL), whereas the second check valve (the right-hand side check valve in FIG. 1) 18 is disposed in fluid line 38 included in the right-hand hydraulic circuit in such a manner as to permit brake fluid flow in one fluid-flow direction from the pump discharge port via fluid line 38 toward front-right wheel-brake cylinder W/C(FR). With such a dual-brake system, in the event that either one of the left and right hydraulic circuits, namely the first brake circuit including fluid lines 33 and 37 through which the discharge port of pump 10 and front-left wheel-brake cylinder W/C(FL) are interconnected and the second brake circuit including fluid lines 34 and 38 through which the discharge port of pump 10 and front-right wheel-brake cylinder W/C(FR) are interconnected, is failed and as a result undesirable working fluid leakage is occurring, it is possible to prevent undesirable outflow of working fluid (brake fluid) from the unfailed brake circuit to the failed brake circuit by means of check valves 17-18. Even if the left-hand brake circuit including fluid lines 33 and 37 associated with front-left wheel-brake cylinder W/C(FL) is failed, hydraulic pressure can be delivered or directed from pump 10 via the unfailed brake circuit including fluid lines 34 and 38 to front-right wheel-brake cylinder W/C(FR). In this manner, even in the presence of the left-hand brake circuit failure, the system enables braking force application to the front-right road wheel by the unfailed brake circuit (the right-hand brake circuit). Likewise, even in the presence of the right-hand brake circuit failure, the system enables braking force application to the front-left road wheel by the unfailed brake circuit (the left-hand-brake circuit).

The brake control system of the first embodiment shown in FIG. 1 is applied to an automotive vehicle employing a front-wheel BBW hydraulic pressure control unit. It will be appreciated that the fundamental concept of the system configuration of the brake control system of the embodiment may be applied to an automotive vehicle employing a four-wheel BBW hydraulic pressure control unit and a so-called diagonal split layout of brake circuits, sometimes termed “X-split layout”, in which one part of the tandem master cylinder output is connected via a first brake pipeline (a first brake circuit) to front-left and rear-right wheel-brake cylinders W/C(FL) and W/C(RR) and the other part is connected via a second brake pipeline (a second brake circuit) to front-right and rear-left wheel-brake cylinders W/C(FR) and W/C(RL). Such an X-split layout is superior in braking-force balance of the vehicle even when either one of the first brake circuit associated with front-left and rear-right wheel-brake cylinders W/C(FL) and W/C(RR) and the second brake circuit associated with front-right and rear-left wheel-brake cylinders W/C(FR) and W/C(RL) is failed. For instance, assuming that the brake circuit associated with front-left wheel-brake cylinder W/C(FL) is failed, the brake circuit associated with rear-right wheel-brake cylinder W/C(RR) becomes failed simultaneously, and thus the system permits simultaneous braking force application to both of the front-right and rear-left road wheels by the unfailed brake circuit (the second brake circuit). Conversely assuming that the brake circuit associated with front-right wheel-brake cylinder W/C(FR) is failed, the brake circuit associated with rear-left wheel-brake cylinder W/C(RL) becomes failed simultaneously, and thus the system permits simultaneous braking force application to both of the front-left and rear-right road wheels by the unfailed brake circuit (the first brake circuit). The use of X-split layout contributes to the enhanced braking-force balance of the vehicle.

### Comparison of Operation and Effects Between Earlier Brake Control System and Improved System of 1st Embodiment

On earlier pressure-accumulator equipped hydraulic brake control systems, hydraulic pressure stored in a pressure accumulator is used to operate wheel brakes of the vehicle. To avoid the hydraulic pressure in the pressure accumulator from continuously acting on each of wheel-brake cylinders, normally-closed valves are disposed in hydraulic circuits between each individual wheel-brake cylinder inlet-and-outlet ports and the pressure accumulator. Only when the brakes must be applied, the normally-closed valves associated with the respective wheel-brake cylinders are opened for wheel-cylinder pressure application. The normally-closed valves also serve as back-flow prevention valve means that prevent the master-cylinder pressure from acting on the pressure accumulator side when the system failure occurs and thus manual braking action is required. However, owing to the use of the pressure accumulator, the pressure-accumulator equipped hydraulic brake control system requires previously-noted normally-closed valves. Thus, each time the braking force has to be applied during the BBW system normal brake operating mode, the normally-closed valves have to be opened (energized). This means the increased energizing time of each of the normally-closed valves, in other words, the increased electric power consumption. The increase in electric power consumption leads to the problem of undesirable heat generation, that is, a fall in viscosity of brake fluid, in other words, the deteriorated brake control accuracy.

On the contrary, in the accumulatorless hydraulic brake control system of the first embodiment shown in FIG. 1, the first check valve 17 is disposed in fluid line 37, which is connected to the manual-brake hydraulic circuit containing fluid lines 31 and 33 and intercommunicates the pump discharge port (pump discharge fluid line 370) and front-left wheel-brake cylinder W/C(FL), for permitting brake fluid flow in one fluid-flow direction from the pump discharge side to front-left wheel-brake cylinder W/C(FL) and preventing any flow in the opposite direction. Likewise, the second check valve 18 is disposed in fluid line 38, which is connected to the manual-brake hydraulic circuit containing fluid lines 32 and 34 and intercommunicates the pump discharge port (pump discharge fluid line 370) and front-right wheel-brake cylinder W/C(FR), for permitting brake fluid flow in one fluid-flow direction from the pump discharge side to front-right wheel-brake cylinder W/C(FR) and preventing any flow in the opposite direction. By means of check valves 17-18, it is possible to ensure the stable brake performance by controlling or regulating hydraulic pressures acting on each of front-left and front-right wheel-brake cylinders W/C(FL) and W/C(FR) by BBW system pump 10. Also, the system of the embodiment eliminates the necessity of the pressure accumulator, thereby ensuring a less wasteful energy consumption, and an enhanced mountability of the system on the vehicle. During the BBW system normal brake operating mode, check valves 17-18 become opened, when the discharge pressure of pump 10 overcomes a predetermined pressure value (in other words, the spring force of each of check valves 17-18). During the fail-safe operating mode (in the presence of the system failure), it is possible to prevent back flow of brake fluid from master cylinder 3 to pump 10 by means of two check valves 17-18 without energizing the electromagnetic valves. Check valves 17-18 also contribute to a reduced electric power consumption, thus avoiding a drop in coefficient of viscosity of brake fluid owing to heat generation, and consequently preventing the brake control accuracy from being deteriorated.

Additionally, in the system of the embodiment, inflow valve 13, comprised of the normally-open, electromagnetic valve, is disposed between check valve 17 and front-left wheel-brake cylinder W/C(FL), whereas inflow valve 14, comprised of the normally-open, electromagnetic valve, is disposed between check valve 18 and front-right wheel-brake cylinder w/C(FR). Therefore, during the BBW system normal brake operating mode, at which wheel-cylinder pressure control for each of front wheel-brake cylinders W/C(FL) and WC(FR) is achieved by pump 10, it is unnecessary to energize two inflow valves (normally-open electromagnetic valves) 13-14. This more remarkably reduces the electric power consumption.

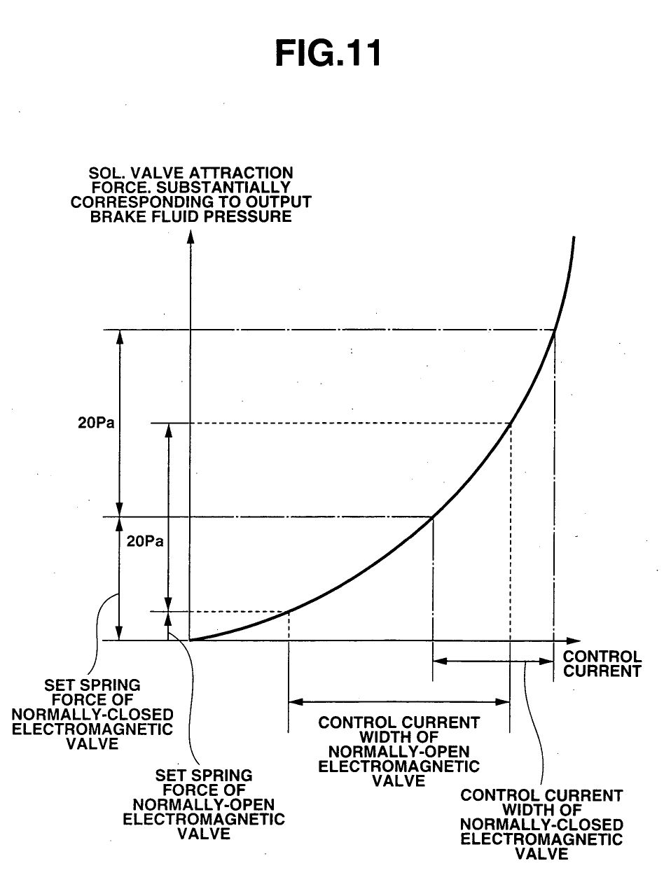

In recent years, in order to enhance the vehicle dynamics control (VDC) performance or the vehicle stability control (VSC) performance, it would be desirable to provide high-precision brake fluid pressure control without any unnatural brake feeling. For instance, when the vehicle is steered during lane-changing, in order to enhance or improve the vehicle's dynamic behavior the VDC system often comes into operation. The VDC system operates to deliver brake fluid pressure to each of wheel-brake cylinders, subjected to VDC control, in such a manner as to stabilize the vehicle attitude without giving the driver uncomfortable brake feeling and without lowering the driving stability during lane-changing. According to the system of the embodiment, brake fluid (working fluid) discharged from the outlet port of pump 10 driven by motor 50 is delivered through pump discharge fluid line 370 and normally-open inflow valve 13 (normally-open inflow valve 14) disposed in fluid line 37 (fluid line 38) into either the left wheel-brake cylinder or the right wheel-brake cylinder. In order to ensure a proper amount of brake fluid, a proper pressure value and/or a proper pressure rise of brake fluid supplied to the wheel-brake cylinder during such a VDC system control mode, it is desirable to produce a very moderate pressure build-up characteristic. That is to say, it is necessary to weaken a sensitiveness of a change in brake fluid pressure to a change in control current applied to the solenoid of inflow valve 13 (inflow valve 14), thus reducing an error of the change in brake fluid pressure with respect to the change in control current. As set forth above, in the system of the embodiment, brake fluid, delivered from pump 10, is controlled by means of normally-open inflow valves 13-14. Such normally-open inflow valves are superior to normally-closed inflow valves, in high-precision brake-fluid control. That is, in comparison with normally-closed inflow valves, normally-open inflow valves 13-14 can more finely precisely control the amount, pressure value, and/or pressure change of brake fluid supplied to the wheel-brake cylinder during the BBW system brake operating mode containing the VDC system control. The system of the embodiment employing the previously-noted normally-open inflow valves 13-14 is advantageous with respect to the enhanced brake control, in particular the enhanced accuracy of vehicle dynamics control. In more detail, as can be seen from the control current versus solenoid valve attraction force characteristic curve shown in FIG. 11, normally-open inflow valves 13-14 are superior to normally-closed inflow valves, in enhanced control resolution (or in improved control system's sensitivity) or in a very moderate-pressure build-up characteristic. As seen from the characteristic curve of FIG. 11, generally, the attraction force created by the solenoid of the electromagnetic inflow valve varies in proportion to a square of the control current value of exciting current applied to the solenoid. Additionally, the set spring force of the return spring of the normally-open inflow valve can be set to a smaller value than that of the normally-closed inflow valve, for the reasons discussed below. That is, in the case of the normally-closed inflow valve, its spring force has to be set to keep its valve-closed state in a fluid-tight fashion even under high brake-fluid pressure. Thus, the set spring force-of the normally-closed inflow valve tends to be set to a comparatively high level, in comparison with the set spring force of the normally-open inflow valve. For the same required brake fluid pressure such as 20 Pa, the normally-open inflow valve can provide a relatively greater control current width, as compared to the normally-closed inflow valve. This means the enhanced control resolution, the improved control system's sensitivity, or the very moderate pressure build-up characteristic. As explained above, the system of the embodiment employing the previously-noted normally-open inflow valves 13-14 is advantageous with respect to the enhanced brake control, in particular the enhanced accuracy of vehicle dynamics control.

By the use of the normally-open inflow valve pair 13, 14 and the check valve pair 17, 18, even when both of inflow valves 13-14 become inoperative owing to wiring-harness breakage, with check valves 17-18 normally operating and inflow valves 13-14 de-energized and fully opened the system of the embodiment can perform a brake-by-wire control mode that permits simultaneous application of the same hydraulic pressure to each of front wheel-brake cylinders W/C(FL) and W/C(FR). This enhances the brake-control-system reliability.

Additionally, as discussed previously, inflow valves 13-14 are comprised of proportional control valves capable of more finely accurately adjusting the valve position. As a basic rule, inflow valves 13-14 remain de-energized during the BBW system normal brake operating mode. Only when there is a necessity to finely accurately control the wheel-cylinder pressures, it is possible to execute wheel-cylinder pressure control by energizing inflow valves 13-14. This eliminates the necessity of continuously energizing the inflow valves during the BBW system normal brake operating mode, thus reducing the energizing time of the inflow valve pair 13-14, and consequently ensuring reduced electric power consumption. Additionally, as discussed previously, the proportional control valve, constructing each of inflow valves 13-14, is superior in reduced noise and vibration, in comparison with an ON/OFF control valve. The use of proportional control valves is advantageous in enhanced noise and vibration control performance. Furthermore, even when a pressure difference between the first and second brake circuits due to a difference of the resistance of the working-fluid passage of the first brake circuit associated with front-left wheel-brake cylinder W/C(FL) to working-fluid flow and the resistance of the working-fluid passage of the second brake circuit associated with front-right wheel-brake cylinder W/C(FR) to working-fluid flow because of each brake-circuit's individual operating characteristics, it is possible to equalize the magnitude of braking force applied to the front-left wheel brake and the magnitude of braking force applied to the front-right wheel brake independently of each other by electronically controlling inflow valves 13-14, constructed by high-precision proportional control valves. This enhances the control accuracy of vehicle dynamics control (VDC) system or vehicle stability control (VSC) system, and thus stabilizes the vehicle dynamic behavior.

Moreover, as discussed previously, in the system of the embodiment using the dual-brake system (the tandem brake system) with the first and second brake circuits, the first check valve 17 is disposed in fluid line 37 included in the first brake circuit in such a manner as to permit brake fluid flow in one fluid-flow direction from the pump discharge side via fluid line 37 toward front-left wheel-brake cylinder W/C(FL) and to prevent any flow in the opposite direction. Likewise, the second check valve 18 is disposed in fluid line 38 included in the second brake circuit in such a manner as to permit brake fluid flow in one fluid-flow direction from the pump discharge side via fluid line 38 toward front-right wheel-brake cylinder W/C(FR) and to prevent any flow in the opposite direction. In the event that either one of two brake circuits, namely the first brake circuit including fluid lines 33 and 37 through which the pump discharge port and front-left wheel-brake cylinder W/C(FL) are interconnected and the second brake circuit including fluid lines 34 and 38 through which the pump discharge port and front-right wheel-brake cylinder W/C(FR) are interconnected, is failed and as a result undesirable working fluid leakage is occurring, it is possible to prevent undesirable outflow of working fluid (brake fluid) from the unfailed brake circuit to the failed brake circuit by means of check valves 17-18. For instance, even in the presence of a failure in the left-hand brake circuit including fluid lines 33 and 37, the system enables braking force application to the front-right road wheel by feeding or supplying hydraulic pressure created by pump 10 via the unfailed brake circuit (the normally-operating, right-hand brake circuit) to front-right wheel-brake cylinder W/C(FR). In a similar manner, even in the presence of a failure in the right-hand brake circuit including fluid lines 34 and 38, the system enables braking force application to the front-left road wheel by supplying hydraulic pressure created by pump 10 via the unfailed brake circuit (the normally-operating, left-hand brake circuit) to front-left wheel-brake cylinder W/C(FL). Although the accumulatorless hydraulic brake control system of the first embodiment of FIG. 1 is applied to an automotive vehicle employing a front-wheel BBW hydraulic pressure control unit, the fundamental concept of the system configuration of the brake control system of the first embodiment may be applied to an automotive vehicle employing a four-wheel BBW hydraulic pressure control unit and an X-split layout of brake circuits. For instance, assuming that the brake circuit associated with front-left wheel-brake cylinder W/C(FL) is failed, the brake circuit associated with rear-right wheel-brake cylinder W/C(RR) becomes failed simultaneously, and thus the system permits simultaneous braking force application to both of the front-right and rear-left road wheels by the unfailed brake circuit (the second brake circuit). Conversely assuming that the brake circuit associated with front-right wheel-brake cylinder W/C(FR) is failed, the brake circuit associated with rear-left wheel-brake cylinder W/C(RL) becomes failed simultaneously, and thus the system permits simultaneous braking force application to both of the front-left and rear-right road wheels by the unfailed brake circuit (the first brake circuit). The use of X-split layout contributes to the enhanced braking-force balance and enhanced vehicle stability in vehicle dynamic behavior.

### Comparison of Operation and Effects Between Earlier ABS-VDC Control System and Improves System of 1st Embodiment

As is generally known, an anti-skid brake system plus vehicle dynamics control system, abbreviated to an “ABS-VDC control system”, is an advanced vehicular stability control system with braking system interaction, capable of avoiding a vehicle's skidding condition and improving vehicle dynamic behavior by building up, holding, and/or reducing each of wheel-cylinder pressures irrespective of the driver's brake-pedal depression amount.

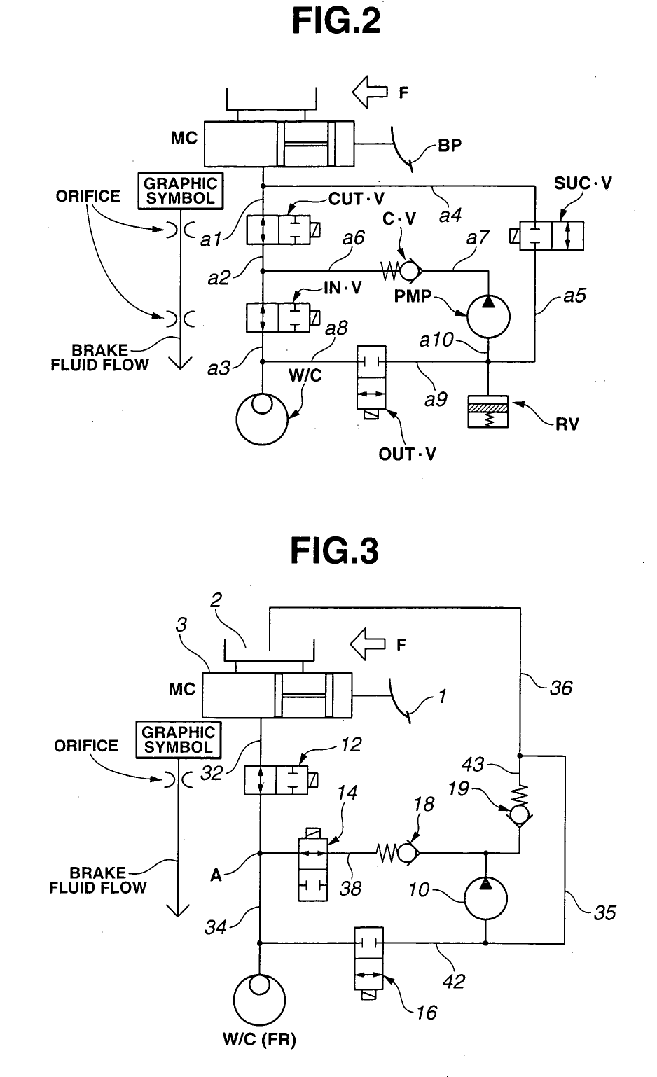

FIG. 2 shows the simplified hydraulic circuit diagram of the earlier ABS-VDC control system. For the sake of illustrative simplicity, the hydraulic circuit for only one wheel-brake cylinder W/C is shown. Actually, the same hydraulic circuit as shown in FIG. 2 is configured for each of a plurality of wheel-brake cylinders. A brake pedal BP is linked to a push rod of a master cylinder MC. A first hydraulic line al is connected to master cylinder MC. A second hydraulic line a2 is connected via a normally-open, cutoff valve CUT-V to the first hydraulic line al. A third hydraulic line a3 is connected via a normally-open, inflow valve IN•V to the second hydraulic line a2. Wheel-brake cylinder W/C is connected to the third hydraulic line a3. A fourth hydraulic line a4 is connected to the first hydraulic line al. A fifth hydraulic circuit a5 is connected through a normally-closed, suction valve SUC•V and the fourth hydraulic line a4 to the first hydraulic line a1. A sixth hydraulic line a6 is connected to the second hydraulic line a2. A seventh hydraulic line a7 is connected to the second hydraulic line a2 through the sixth hydraulic line a6 and a one-way check valve C•V that permits brake fluid flow in one fluid-flow direction from a discharge port of a pump PMP to the master cylinder side, and to prevent any flow in the opposite direction. An eighth hydraulic line a8 is connected to the third hydraulic line a3. A ninth hydraulic line a9 is connected to the third hydraulic line a3 through a normally-closed, outflow valve OUT•V and the eighth hydraulic line a8. The fifth and ninth hydraulic lines a5 and a9 are connected to a reservoir (a pressure accumulator) RV. The fifth and ninth hydraulic lines a5 and a9 are also connected via a tenth hydraulic line a10 to an inlet port of pump PMP. The seventh hydraulic line a7 is connected to the pump discharge port.

<Wheel-Brake Cylinder Pressure Build-Up/Reduction Control based on VDC System Control>

With the previously-noted arrangement of the earlier ABS-VDC control system shown-in FIG. 2, when wheel-cylinder pressure build-up command signals are output from the electronic control unit to the respective automatic brake actuators (that is, electromagnetic solenoid valves, more exactly, normally-open, cutoff valve CUT•V, normally-closed, suction valve SUC•V, normally-open, inflow valve IN•V, and normally-closed, outflow-valve OUT•V) included in the earlier ABS-VDC control system. Responsively to the pressure build-up command signals, normally-open cutoff valve CUT-V is energized and closed, normally-closed suction valve SUC-V is energized and opened, normally-open inflow valve IN•V remains de-energized and opened, and normally-closed outflow valve OUT•V remains de-energized and closed. Under these conditions, when pump PMP is driven, brake fluid is inducted or sucked into the pump inlet port through the fourth hydraulic line a4, the fifth hydraulic line a5, and the tenth hydraulic line a10. Then, during the pressure build-up operating mode, high-pressure brake fluid pressurized and discharged by pump PMP is supplied to wheel-brake cylinder W/C through the seventh hydraulic line a7, the sixth hydraulic line a6, the second-hydraulic line a2, and the third hydraulic line a3. Therefore, it is possible to automatically control or regulate the wheel-brake cylinder pressure irrespective of the driver's brake-pedal depression. Conversely during the pressure reduction operating mode, pump PMP is stopped, normally-closed outflow valve OUT-V is energized and opened, and whereby brake fluid in wheel-brake cylinder W/C flows into reservoir RV.

<Wheel-Brake Cylinder Pressure Build-Up/Reduction Control Based on ABS System Control>

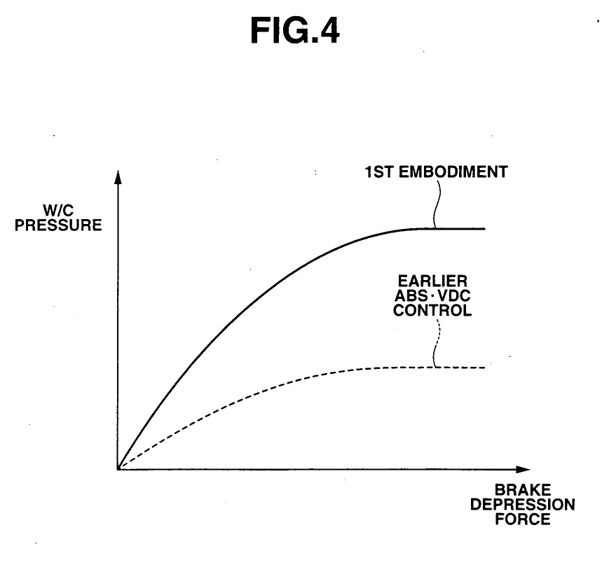

With the previously-noted arrangement of-the earlier ABS-VDC control system shown in FIG. 2, if the brakes are applied so hard, that the road wheels tend to stop turning, and thus a skid starts to develop, the ABS system comes into operation. During the pressure reduction operating mode of skid control, normally-open inflow valve IN•V is energized and closed to block fluid communication between master cylinder MC and wheel-brake cylinder W/C. On the other hand, during the pressure reduction operating mode, normally-closed outflow valve OUT•V is energized and opened, and whereby brake fluid in wheel-brake cylinder W/C is flown into reservoir RV. On the contrary, during the pressure build-up operating mode of skid control, normally-closed outflow valve OUT•V is de-energized and closed, while normally-open inflow valve IN•V is deenergized and opened. Thus, during the pressure build-up operating mode, master-cylinder pressure is supplied to wheel-brake cylinder W/C. As discussed above, in the earlier ABS-VDC control system shown in FIG. 2, during the pressure build-up operating mode of skid control, the system utilizes the master-cylinder pressure created by the driver's brake pedal depression for pressure build-up. During the pressure reduction operating mode of skid control, fluid communication between master cylinder MC and wheel-brake cylinder W/C is blocked. Thus, normally-open inflow valve IN-V must be disposed in the hydraulic circuit provided between master cylinder MC and wheel-brake cylinder W/C. For the reasons discussed above, normally-open cutoff valve CUT•V is disposed between the first and second hydraulic lines a1 and a2, whereas normally-open inflow valve IN•V is disposed between the second and third hydraulic lines a2 and a3. In the event that the ABS-VDC control system failure, in particular, the electric system failure occurs, the electric power supply is intercepted, and thus all of the electromagnetic solenoid valves CUT•V, SUC•V, IN-V, and OUT-V are de-energized and held at their spring-loaded valve positions (unactuated or de-energized original positions). That is, normally-open cutoff valve CUT-V is kept opened, normally-closed suction valve SUC-V is kept closed, normally-open inflow valve IN•V is kept opened, and normally-closed outflow valve OUT-V is kept closed, thus ensuring or producing manual braking action based on the master-cylinder pressure, whose pressure value is determined by the driver's brake-pedal depression force. However, during manual braking, as can be seen from the circuit diagram of FIG. 2, when hydraulic pressure is supplied from the master cylinder through the first, second, and third hydraulic lines a1, a2, and a3 to wheel-brake cylinder W/C, brake fluid has to be delivered into the wheel-brake cylinder via two valves CUT-V and IN•V. These valves CUT•V and IN•V, disposed in the fluid lines a1-a3 of the manual-brake hydraulic circuit, also serve as fluid-flow constriction orifices. Such a system would require a great brake-pedal depression force (see the brake-depression-force versus wheel-brake cylinder pressure characteristic curve, obtained by the earlier ABS-VDC control system of FIG. 2 and indicated by the broken line in FIG. 4).

FIG. 3 shows the simplified hydraulic circuit diagram of the accumulatorless hydraulic brake control system of the first embodiment. In FIG. 3, for the sake of simplicity, the brake circuit for only the front-right wheel-brake cylinder W/C(FR) is shown. In FIG. 3, a fluid line denoted by reference sign 35 corresponds to a connection line, interconnecting the pump inlet side and the joining point of fluid lines 36 and 43. As previously described in reference to the paragraphs <DURING WHEEL-CYLINDER PRESSURE BUILD-UP OPERATING MODE>, <DURING WHEEL-CYLINDER PRESSURE HOLD OPERATING MODE>, and <DURING WHEEL-CYLINDER PRESSURE REDUCTION OPERATING MODE>, when either ABS system control (skid control) or VDC system control (vehicle dynamics control) is performed by the system of the first embodiment, brake fluid pressure is supplied from pump 10 to wheel-brake cylinder W/C (front-right wheel-brake cylinder W/C(FR) in FIG. 3). Thus, in the system of the first embodiment, inflow valve 14 shown in FIG. 3, corresponding to inflow valve IN-V of FIG. 2, is disposed in the fluid line 38, which interconnects check valve 18 and the joining point A of fluid lines 32 and 34. In the event that the ABS-VDC control system failure, in particular, the electric system failure occurs, the electric power supply is intercepted, and thus all of the electromagnetic solenoid valves 12, 14, and 16 are de-energized and held at their spring-loaded positions, the master-cylinder pressure can be supplied from mater cylinder 3 to the wheel-brake cylinder via only the shutoff valve 12. During the fail-safe operating mode, in other words, during manual braking, only one valve, namely shutoff valve 12 fully opened, serves as a fluid-flow constriction orifice. Thus, it is possible to produce the desired wheel-brake cylinder pressure by a comparatively light brake-pedal depression force (see the brake-depression-force versus wheel-brake cylinder pressure characteristic curve, obtained by the accumulatorless hydraulic brake control system of the first embodiment of FIG. 3 and indicated by the solid line in FIG. 4). As can be seem from comparison between the two characteristic curves shown in FIG. 4, for the same brake-pedal depression force, the system of the first embodiment can generate a relatively high wheel-brake cylinder pressure.

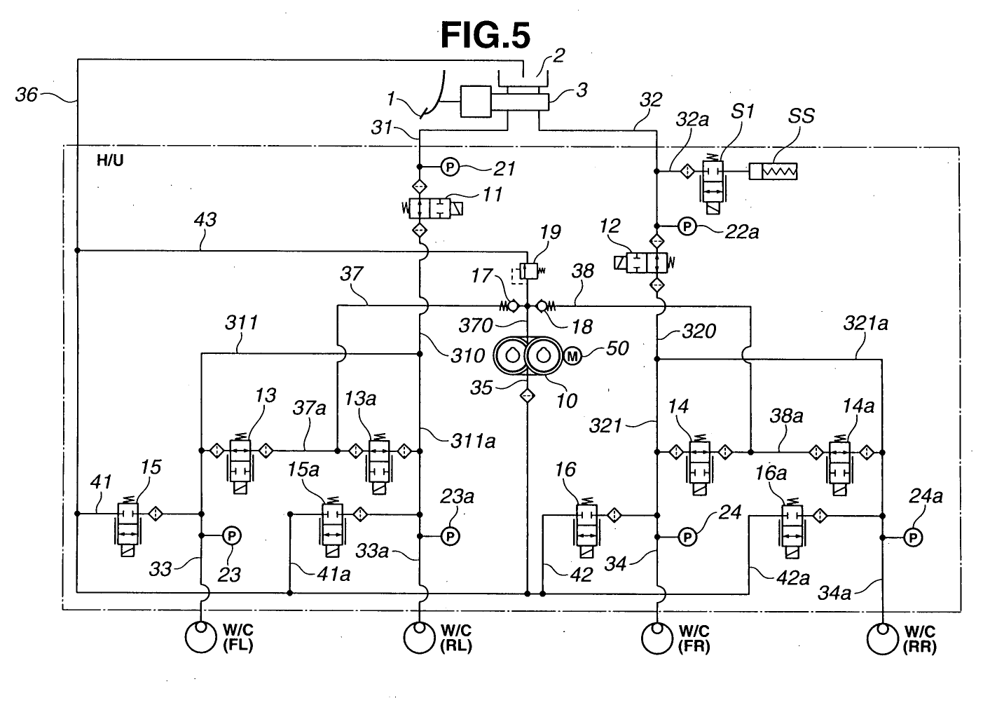

Referring now to FIG. 5, there is shown the accumulatorless hydraulic brake control system of the second embodiment, which is exemplified in an automotive vehicle employing a four-wheel brake-by-wire (BBW) hydraulic pressure control unit. The basic construction of the brake control system of the second embodiment is similar to that of the first embodiment. In explaining the second embodiment, for the purpose of simplification of the disclosure, the same reference signs used to designate elements in the first embodiment will be applied to the corresponding elements used in the second embodiment, while detailed description of the same reference signs will be omitted because the above description thereon seems to be self-explanatory.

As shown in FIG. 5, front-left wheel-brake cylinder W/C(FL) is connected through fluid lines 33, 311, 310, and 31 to the first part of the tandem master cylinder output. Front-right wheel-brake cylinder w/C(FR) is connected through fluid lines 34, 321, 320, and 32 to the second part of the tandem master cylinder output. Rear-left wheel-brake cylinder W/C(RL) is connected through fluid lines 33a, 311a, 310, and 31 to the first part of the tandem master cylinder output. Rear-right wheel-brake cylinder W/C(RR) is connected through fluid lines 34a, 321a, 320, and 32 to the second part of the tandem master cylinder output. Normally-open shutoff valve 11 is disposed in fluid line 31, while normally-open shutoff valve 12 is disposed in fluid line 32. During the four-channel BBW system normal brake operating mode (i.e., during the four-wheel BBW system normal brake operating mode), shutoff valves 11-12 are both closed. On the contrary, during the fail-safe operating mode, the first and second normally-open shutoff valves 11-12 are both opened. Each of shutoff valves 11-12 is comprised of a normally-open, two-port two-position, electromagnetic shutoff valve. Therefore, even if the electric system failure occurs, these shutoff valves 11-12 are automatically held at their fully-opened positions for failsafe purposes, and whereby it is possible to establish the manual-brake hydraulic circuit. A branch fluid line 32a is branched from fluid line 32 substantially at a midpoint of the fluid-line section between the second port of master cylinder 3 and shutoff valve 12. Disposed in branch fluid line 32a is a stroke simulator SS, which is provided to store or reserve brake fluid via a normally-closed, two-port two-position, electromagnetic shutoff valve Si. Stroke simulator SS is compactly built in the hydraulic pressure control unit (H/U), but not connected to the fluid line of the master-cylinder side. This is advantageous with respect to reduced number of fittings to connect hydraulic lines between various components in the system, reduced oil leakage due to fewer fittings, and lower system installation time and costs. As can be appreciated from the hydraulic circuit diagram of FIG. 5, the system of the second embodiment is also constructed as an accumulatorless brake control system, and the standard accumulator installation space is utilized as an installation space for stroke simulator SS. Therefore, a limited space around master cylinder 3 can be more effectively utilized. Stroke simulator SS is used only in order to store brake fluid, and thus the existing tandem master cylinder can be applied or utilized. This is advantageous with respect to smaller space requirements of overall system, and reduced system manufacturing costs.

Fluid pressure sensors 21 and 22a are connected to or located on the respective fluid lines 31 and 32. Fluid pressure sensors 23, 23a, 24, and 24a are connected to or located on the respective fluid lines 33, 33a, 34, and 34a, respectively connected to front-left, rear-left, front-right, and rear-right wheel-brake cylinders W/C(FL), W/C(RL), W/C(FR), and W/C(RR). As can be seen from the hydraulic circuit diagram of FIG. 5, fluid pressure sensors 21, 22a, 23, 23a, 24, and 24a are connected to the respective fluid lines defined in the hydraulic pressure control unit (H/U), indicated by the one-dotted line in FIG. 5. That is, fluid pressure sensors 21, 22a, 23, 23a, 24, and 24a are compactly built in the hydraulic pressure control unit (H/U). In a similar manner to the first embodiment, pump 10 is disposed between the pump inlet fluid line 35 and pump discharge fluid line 370. Pump inlet fluid line 35 is connected via fluid line 36 to reservoir 2. Pump discharge fluid line 370 is connected to fluid line 43 via check valve (or pressure relief valve) 19. Pump discharge fluid line 370 is also connected via check valve 17, serving as back-flow preventing means, to one end of fluid line 37. Additionally, pump discharge fluid line 370 is connected via check valve 18, serving as back-flow preventing means, to one end of fluid line 38. The other end (the downstream end with respect to pump 10) of fluid line 37 is connected to a fluid line 37a. A pair of normally-open, two-port two-position, electromagnetic proportional control inflow valves 13 and 13a are disposed in fluid line 37a and provided on both sides of the joining point of fluid lines 37 and 37a. One end of fluid line 37a is connected to fluid line 311, while the other end of fluid line 37a is connected to fluid line 311a. In a similar manner, the other end (the downstream end with respect to pump 10) of fluid line 38 is connected to a fluid line 38a. A pair of normally-open, two-port two-position, electromagnetic proportional control inflow valves 14 and 14a are disposed in fluid line 38a and provided on both sides of the joining point of fluid lines 38 and 38a. One end of fluid line 38a is connected to fluid line 321, while the other end of fluid line 38a is connected to fluid line 321a. Fluid line 41 is bridged or joined between fluid line 36 and the connecting point of fluid lines 311 and 33. Normally-closed, two-port two-position, electromagnetic proportional control outflow valve 15 is disposed in fluid line 41. Likewise, fluid line 42 is bridged or joined between fluid line 36 and the connecting point of fluid lines 321 and 34. Normally-closed, two-port two-position, electromagnetic proportional control outflow valve 16 is disposed in fluid line 42. A fluid line 41a is bridged or joined between fluid line 36 and the connecting point of fluid lines 311a and 33a. A normally-closed, two-port two-position, electromagnetic proportional control outflow valve 15a is disposed in fluid line 41a. A fluid line 42a is bridged or joined between fluid line 36 and the connecting point of fluid lines 321a and 34a. A normally-closed, two-port two-position, electromagnetic proportional control outflow valve 16a is disposed in fluid line 42a.

[BBW System Normal Operating Mode]

Regarding the accumulatorless hydraulic brake control system of the second embodiment, the operation of the first brake system for front-left and rear-left wheel-brake cylinders W/C(FL) and w/C(RL) is basically identical to that of the second brake system for front-right and rear-right wheel-brake cylinders w/C(FR) and W/C(RR). In explaining the operation of the four-wheel (four-channel) brake-by-wire (BBW) system of FIG. 5, for the purpose of simplification of the disclosure, only the operation of the left-wheel side brake system (the first brake system) is hereunder explained. When the four-wheel (four-channel) BBW system comes into operation, normally-closed shutoff valve S1 is energized and opened, whereas normally-open shutoff valves 11-12 are energized and closed. Under these conditions, when brake pedal 1 is depressed by the driver, brake fluid in master cylinder 3 is supplied from fluid line 32 into fluid line 32a, and then supplied via shutoff valve S1 into stroke simulator SS. In this manner, stroke simulator SS permits exhaust of working fluid (brake fluid) from master cylinder 3, while applying a proper braking reaction force (a feedback pedal-depression reaction force) to brake pedal 1 during the BBW system normal brake operating mode. At this time, the BBW system controller arithmetically calculates or computes a desired wheel-brake cylinder pressure based on both of the brake-pedal stroke and/or the brake-pedal depression force, and outputs a command signal (a drive current) corresponding to the desired wheel-brake cylinder pressure to motor 50. When motor 50 is rotated in response to the command signal (the drive current) and thus pump 10 is driven, brake fluid is supplied from the pump discharge port through check valve 17 and fluid line 37 into fluid line 37a, and then delivered through normally-open inflow valves 13 and 13a disposed in fluid line 37a into respective wheel-brake cylinders W/C(FL) and W/C(RL). Thus, wheel-cylinder pressures in wheel-brake cylinders W/C(FL) and W/C(RL) are increased up to their desired wheel-cylinder pressure values. Conversely when the wheel-cylinder pressures have to be reduced during the BBW system normal brake operating mode, motor 50 is de-energized and thus pump 10 is stopped, and additionally normally-closed outflow valves 15 and 15a are energized and opened. As a result, wheel-cylinder pressures in front-left and rear-left wheel-brake cylinder W/C(FL) and W/C(RL) are relieved and pressure-reduced, and part of brake fluid in each of front-left and rear-left wheel-brake cylinders W/C(FL) and W/C(RL) is returned through fluid lines 33-33a, outflow valves 15-15a opened, fluid lines 41-41a, and fluid line 36 to reservoir 2. Generally, when the accelerator pedal has been released, there is an increased tendency for the brake pedal to be depressed by the driver. Thus, in the presence of the accelerator pedal release, pump 10 is driven in advance, so that the clearance between the friction pad of the brake caliper of the wheel-brake cylinder and the brake disk is automatically decreasingly compensated for or adjusted and thus quick braking action can be produced by relatively little brake pedal movement. This ensures a high braking response during the BBW system normal brake operating mode.

[Fail-Safe Operating Mode]

During the fail-safe operating mode initiated when a system failure, such as a failure in motor 50, a failure in pump 10, and/or an electric system failure, occurs, all of the electromagnetic valves are de-energized. Thus, normally-closed shutoff valve S1 is de-energized and closed, while normally-open shutoff valves 11-12 are de-energized and opened. With shutoff valves 11-12 fully opened, when brake pedal 1 is depressed, master-cylinder pressure is applied directly into front-left and rear-left wheel-brake cylinder W/C(FL) and W/C(RL) through fluid lines 31, 310, 311-311a, and 33-33a. Regarding the left-wheel side brake system (the first brake system) for front-left and rear-left wheel-brake cylinders W/C(FL) and W/C(RL), during manual braking, as can be seen from the circuit diagram of FIG. 5, only one valve, namely shutoff valve 11 fully opened, serves as a fluid-flow constriction orifice. Thus, it is possible to produce the desired wheel-brake cylinder pressure by a comparatively light brake-pedal depression force. During the fail-safe operating mode, although normally-open inflow valves 13 and 13a is de-energized and opened, fluid lines 37a and 37 are closed by means of check valve 17, thus there is no brake fluid flow from the fluid lines 37a and 37 into the pump discharge side. As set out above, the accumulatorless hydraulic brake control system of the second embodiment of FIG. 5, having the hydraulic modulator construction substantially similar to the first embodiment of FIG. 1, is capable of performing brake-by-wire system control for four wheel-brake cylinder pressures.

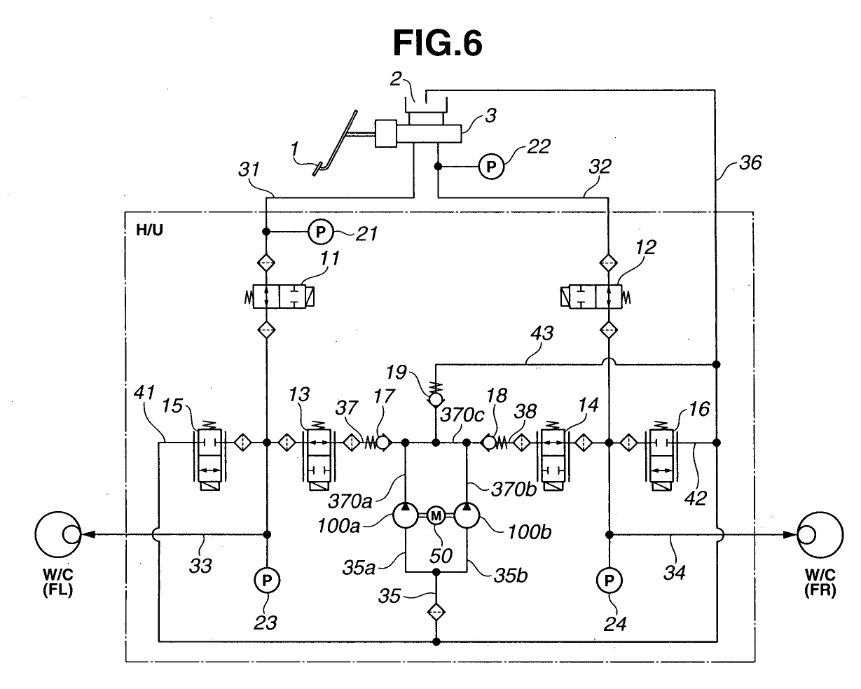

Referring now to FIG. 6, there is shown the accumulatorless hydraulic brake control system of the third embodiment, which is exemplified in an automotive vehicle employing a front-wheel brake-by-wire (BBW) hydraulic pressure control unit. The basic construction of the brake control system of the third embodiment is similar to that of the first embodiment. In explaining the third embodiment, for the purpose of simplification of the disclosure, the same reference signs used to designate elements in the first embodiment will be applied to the corresponding elements used in the third embodiment, while detailed description of the same reference signs will be omitted because the above description thereon seems to be self-explanatory. The brake control system of the third embodiment is slightly different from that of the first embodiment, in that in the system of the third embodiment uses a tandem plunger pump 100 instead of using gear pump 10.

Tandem plunger pump 100 is comprised of a first plunger pump 100a and a second plunger pump 100b. The right-hand axial end of a plunger of the first plunger pump 100a and the left-hand axial end of a plunger of the second plunger pump 100b are cam-connection with a rotary cam fixedly connected to the motor shaft of motor 50. During rotation of motor 50, rotary motion of the rotary cam is converted into reciprocating motions of the first and second plungers. During rotation of motor 50, when one of the first and second plunger pumps 100a-100b is conditioned in the suction stroke, the other plunger pump is conditioned in the discharge stroke. The first plunger pump 100a is located between a first suction line (or a first inlet line) 35a and a first discharge line 370a. The second plunger pump 100b is located between a second suction line (or a second inlet line) 35b and a second discharge line 370b. The first and second discharge lines 370a and 370b are connected to a discharge-side common fluid line 370c. Common fluid line 370c is connected via check valve 17 to fluid line 37, and also connected via check valve 18 to fluid line 38. Common fluid line 370c is also connected to fluid line 43 via check valve (or pressure relief valve) 19.

Pressure-hold and pressure-reduction operating modes, performed by the system of the third embodiment during the BBW system normal brake operating mode, are similar to those of the first embodiment. Only the pressure build-up operating mode is peculiar to the system of third embodiment. The pressure build-up operating mode executed by the system of the third embodiment of FIG. 6 is hereunder explained in detail. Suppose that the first plunger pump 100a is now operated in the suction stroke and the second plunger sump 100b is now operated in the discharge stroke, during rotation of motor 50. At this time, brake fluid pressure in the first discharge line 370a becomes low, while brake fluid pressure in the second discharge line 370b becomes high. Therefore, in the presence of brake fluid pressure supply from both of the first and second discharge lines 370a-370b to common fluid line 370c, low and high brake fluid pressures in the first and second discharge lines 370a-370b are blended to produce a leveled brake fluid pressure (or a uniformalized discharge pressure). Thereafter, when the first plunger pump 100a is shifted to the discharge stroke and the second plunger pump 100b is shifted to the suction stroke, due to further rotation of motor 50, brake fluid pressure in the first discharge line 370a becomes high, while brake fluid pressure in the second discharge line 370b becomes low. In a similar manner, high and low brake fluid pressures in the first and second discharge lines 370a-370b are blended within common fluid line 370c to produce a leveled brake fluid pressure (or a uniformalized discharge pressure). Thus, during repeated executions of one complete pumping cycle of tandem plunger pump 100, that is, suction and discharge strokes, the system of the third embodiment employing tandem plunger pump 100 can produce very stable discharge pressure. As is generally known, a single plunger pump is inferior to a gear pump in less brake-fluid pulsations (less variations in the discharge amount of working fluid), due to repeated executions of suction and discharge strokes at a relatively shorter execution cycle. To suppress undesirable brake-fluid pulsations, the system of the third embodiment uses a dual plunger pump structure (a tandem plunger pump structure) that permits blending and uniformalizing of high and low discharge pressures within common fluid line 370c. The tandem plunger pump can be designed such that the period of a discharge stroke of the tandem plunger pump is shorter than that of the single plunger pump. The shorter period of the discharge stroke ensure a stable, continuous brake-fluid discharge, thereby enhancing the accuracy of pressure build-up control.

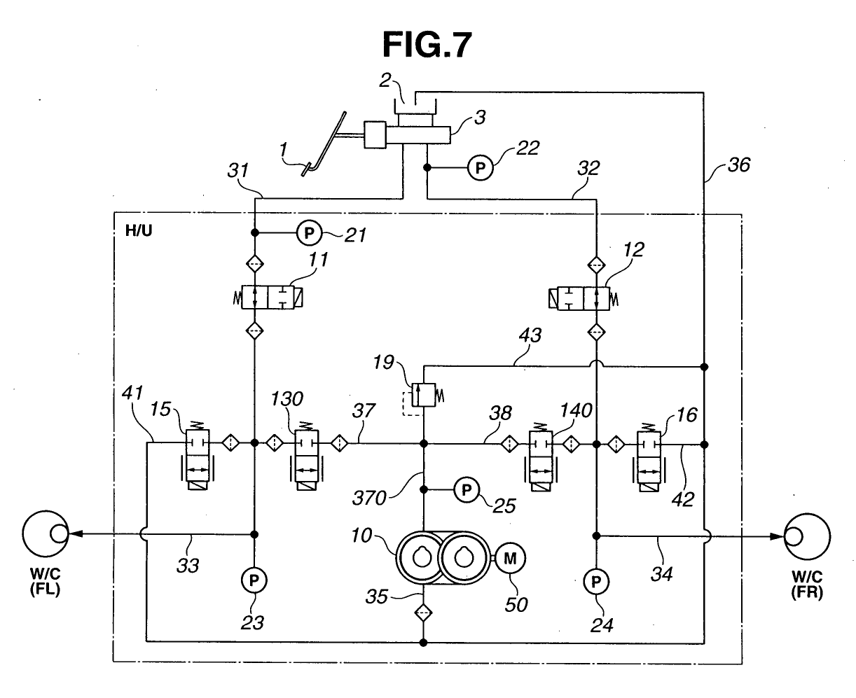

Referring now to FIG. 7, there is shown the accumulatorless hydraulic brake control system of the fourth embodiment, which is exemplified in an automotive vehicle employing a front-wheel brake-by-wire (BBW) hydraulic pressure control unit. The basic construction of the brake control system of the fourth embodiment is similar to that of the first embodiment. In explaining the fourth embodiment, for the purpose of simplification of the disclosure, the same reference signs used to designate elements in the first embodiment will be applied to the corresponding elements used in the fourth embodiment, while detailed description of the same reference signs will be omitted because the above description thereon seems to be self-explanatory. The brake control system of the fourth embodiment is different from that of the first embodiment, in that the system of the fourth embodiment uses normally-closed, two-port two-position, electromagnetic proportional control inflow valves 130 and 150 instead of using normally-open electromagnetic proportional control inflow valves 13-14 without using check valves 17-18.

[BBW System Normal Operating Mode]

During the front-wheel (two-channel) brake-by-wire (BBW) system normal brake operating mode, the stroke of brake pedal 1 is detected by means of the stroke sensor, located near master cylinder 3. Pump 10 is driven responsively to the driver's brake-pedal depression amount (the brake-pedal stroke) detected by the stroke sensor, so that the actual wheel-brake cylinder pressure of each of wheel-brake cylinders W/C(F/L) and W/C(F/L) is brought closer to a desired wheel cylinder pressure value determined based on the detected brake-pedal stroke in accordance with brake-by-wire (BBW) control. During the BBW system normal brake operating mode, in order to prevent master-cylinder pressure from being delivered into each of front-left and front-right wheel-brake cylinders W/C(FL) and W/C(FR), two shutoff valves 11-12 are both closed and held at their shutoff states so as to block or shut off fluid communication between the first port of master cylinder 3 and front-left wheel-brake cylinder W/C(FL) and simultaneously block or shut off fluid communication between the second port of master cylinder 3 and front-right wheel-brake cylinder W/C(FR).

<During Wheel-Cylinder Pressure Build-Up Operating Mode>

During pressure buildup at the BBW system normal brake operating mode, two shutoff valves 11-12 are held at their shutoff states (at energized states) and pump 10 is operated by motor 50, such that brake fluid in reservoir 2 is inducted through fluid line 36 via fluid line 35 into the inlet port of-pump 10. At this time, normally-closed inflow valves 130-140 are shifted to their full-open states (to energized states). On the other hand, outflow valves 15-16 are held at their normally-closed states (at de-energized states). Thus, brake fluid pressurized by pump 10 is delivered through fluid line 37 and fail-safe fluid line 33 into front-left wheel-brake cylinder W/C(FL), and simultaneously the pressurized brake fluid is delivered through fluid line 38 and fail-safe fluid line 34 into front-right wheel-brake cylinder W/C(FR), for wheel-cylinder pressure build-up. When the fluid pressure in the discharge side of pump 10 exceeds the set pressure of relief valve 19, relief valve 19 is opened to relieve surplus pressure beyond the set pressure and to return part of pressurized brake fluid to reservoir 2, for fail-safe purposes of the pressured system.

<During Wheel-Cylinder Pressure Hold Operating Mode>

During pressure hold at the BBW system normal brake operating mode, shutoff valves 11-12 are kept at their shutoff states (at energized states) and outflow valves 15-16 are kept at their closed states (at de-energized states), while inflow valves 130 and 140 are kept at their closed states (at de-energized states) for wheel-cylinder pressure hold. When the pressure hold mode is maintained for a time period longer than a specified constant time period, motor 50 and pump 10 are both shifted to their inoperative states, and a pressure-relief time, during which the surplus pressure produced by pump 10 is relieved via relief valve 19 and brake fluid discharged from pump 10 flows through relief valve 19 into reservoir 2, can be effectively reduced or shortened, thus enhancing the energy efficiency. This contributes to a reduced fuel consumption rate. In the brake control system of the fourth embodiment, inflow valves 130 and 140 and outflow valves 15 and 16 are all constructed by normally-closed electromagnetic proportional control valves. Therefore, when brake fluid pressure has to be temporarily charged or stored in each of wheel-brake cylinders according to hill hold control during a vehicle starting period on a hill, it is possible to charge brake fluid pressure in each individual wheel-brake cylinder by means of these normally-closed electromagnetic proportional control valves 130, 140, 15, and 16 without any electric power consumption.

<During Wheel-Cylinder Pressure Reduction Operating Mode>

During pressure reduction at the BBW system normal brake operating mode, shutoff valves 11-12 are held at their shutoff states (at energized states) and inflow valves 130 and 140 are kept at their closed states (at de-energized states), while outflow valves 15-16 are opened in accordance with proportional control. Thus, wheel-cylinder pressure in front-left wheel-brake cylinder W/C(FL) is relieved and pressure-reduced, and part of brake fluid in front-left wheel-brake cylinder W/C(FL) is returned through fail-safe fluid line 33, outflow valve 15 opened, branch fluid line 41, and fluid line 36 to reservoir 2. Simultaneously, wheel-cylinder pressure in front-right wheel-brake cylinder W/C(FR) is relieved and pressure-reduced, and part of brake fluid in front-right wheel-brake cylinder W/C(FR) is returned through fail-safe fluid line 34, outflow valve 16 opened, branch fluid line 42, and fluid line 36 to reservoir 2. When a holding time, during which inflow valves 130 and 140 are held at their closed states (at de-energized states), exceeds a specified constant time period, in the same manner as the pressure-hold operating mode, motor 50 and pump 10 are shifted to their inoperative states (stopped states). This contributes to a reduction in driving time of motor 50.

[Fail-Safe Operating Mode]

When a system failure, such as a failure in motor 50, a failure in pump 10, and/or an electric system failure, occurs, shutoff valves 11-12 are held at their fully-opened positions (at de-energized states). With shutoff valves 11-12 fully opened, master-cylinder pressure is applied directly into front-left wheel-brake cylinder W/C(FL) through the first fluid line 31 and the first fail-safe fluid line 33, and simultaneously applied directly into front-right wheel-brake cylinder w/c(FR) through the second fluid line 32 and the second fail-safe fluid line-34, such that a braking force is created by way of manual braking action. In the brake control system of the fourth embodiment, during the fail-safe operating mode (in the presence of the system failure), on the one hand, shutoff valves 11-12 can be automatically held at their fully-opened positions (at de-energized states), since shutoff valves 11-12 are comprised of normally-open electromagnetic shutoff valves. During the fail-safe operating mode, on the other hand, inflow valves 130 and 140 can be automatically held at their fully-closed positions (at de-energized states), since inflow valves 130 and 140 are comprised of normally-closed electromagnetic proportional control valves. Thus, during the fail-safe operating mode, it is possible to insure or produce manual braking action based on the driver's brake pedal depression. During the fail-safe operating mode, with normally-closed electromagnetic proportional control inflow valves 130 and 140 closed, there is a less risk of brake-fluid leakage from fluid lines 31-32 through oil pump 10 into reservoir 2. Normally-closed electromagnetic proportional control inflow valves 130 and 140 incorporated in the system of the fourth embodiment of FIG. 7, eliminates the necessity of check valves 17-18 used in the system of the first embodiment of FIG. 1. The system of the fourth embodiment requires electric power supply (exciting current supply) to inflow valves 130 and 140 only during the wheel-cylinder pressure build-up operating mode. The system of the fourth embodiment of FIG. 7 is superior to the system of the first embodiment of FIG. 1, in simplified hydraulic system configuration.

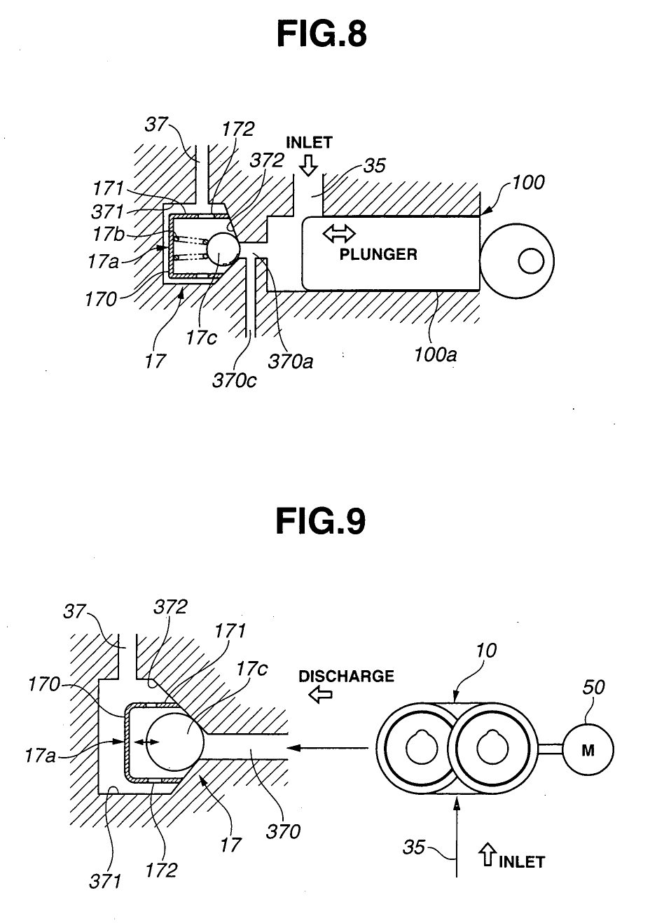

Referring now to FIG. 8, there is shown the detailed cross-section of check valves 17-18 and tandem plunger pump 100 incorporated in the accumulatorless hydraulic brake control system of the third embodiment of FIG. 6. The check valve structure is the same for two check valves 17-18 shown in FIG. 6. For the sake of simplicity, the valve structure for only the left-hand side one-way check valve 17 associated with the first plunger pump 100a is hereunder explained. Check valve 17 is operably accommodated or housed in a check-valve housing chamber 371, which is defined in the joining portion of the first discharge line (also serving as the plunger pump discharge port) 370a and fluid line 37. A part of an inner peripheral wall portion of check-valve housing chamber 371, corresponding to the perimeter of the first discharge line 370a, is formed as a substantially conically tapered, concave wall surface 372. Check valve 17 is comprised of a socket 17a, a spring 17b, and a ball (a check-valve element) 17c. Socket 17a is comprised of a substantially disk-shaped bottom end portion 170 serving as a spring seat for the left-hand axial end of spring 17b and a substantially cylindrical portion 171 closed at the left-hand axial end by the bottom end portion 170 and having an opening end communicating the first discharge line 370a. The substantially cylindrical portion 171 of socket 17a is formed with a plurality of radially bored communication holes 172 that intercommunicate fluid line 37 and the internal space of socket 17. The opening end of the substantially cylindrical portion 171 is arranged in such a manner as to surround the perimeter of the first discharge line 370a. Spring 17b is disposed between the bottom end portion 170 of socket 17a and ball 17c, such that ball 17c is axially biased or spring-loaded by a predetermined preload (a set spring load), and thus the right-hand axial end of spring 17b forces ball 17c to usually block fluid flow from the first discharge line 370a toward fluid line 37. The set spring load of spring 17b is set to a sufficient spring force to suppress brake-fluid pulsations of the first plunger pump 100a. Actually the set spring load of spring 17b is determined or designed depending on the pump performance. As can be seen from the cross section of FIG. 8, the outside diameter of ball 17c is dimensioned to be greater than the inside diameter of the first discharge line 370a being substantially circular in lateral cross section, such that ball 17c fully closes the opening end of the first discharge line 370a when the hydraulic pressure in the first discharge line 370a is less than the spring force. The operation of check valve 17 of FIG. 8 is hereunder described in detail.

When motor 50 is rotated and the first plunger pump 100a is operating on its suction stroke, brake fluid pressure in the first discharge line 370a becomes low. Thus, fluid communication between the first discharge line 370a and fluid line 37 tends to be blocked by way of the spring force acting on ball 17c. At this time, if the second plunger pump 100b is operating on its discharge stroke and as a result brake fluid pressure in the second discharge line 370b becomes high, the high fluid pressure can be supplied via common fluid line 370c to discharge line 370a. In the presence of high fluid pressure from discharge line 370a via common fluid line 370c to discharge line 370a, the hydraulic pressure of brake fluid blended within common fluid line 370c overcomes the spring force and thus check valve 17 becomes shifted to a free-flow condition. Next, when plunger stroke of the first plunger pump 100a shifts to its discharge stroke, brake fluid pressure in the first discharge line 370a begins to rise. Immediately when the fluid pressure in the first discharge line 370a exceeds the set spring load of spring 17b, ball 17c begins to axially leftwards in such a manner as to move away from the opening end of the first discharge line 370a. As a result, fluid communication between the first discharge line 370a and check-valve housing chamber 371 is established. Under these conditions, brake fluid is introduced from the pump discharge side (the first discharge line 370a) into the internal space of socket 17a, and then discharged via communication holes 172 of substantially cylindrical portion 171 into fluid line 37. Thereafter, when the plunger stroke of the first plunger pump 100a shifts again to its suction stroke, brake fluid pressure in the first discharge line 370a begins to fall. Immediately when the fluid pressure in is the first discharge line 370a becomes less than the set spring load of spring 17b, the first discharge line 370a is shut off by means of the spring-loaded ball 17c. As a result, brake fluid can be efficiently introduced through pump inlet fluid line 35 into the plunger chamber in which the plunger of the first plunger pump 100a is axially slidably accommodated. With the first discharge line 370a shut off by mean of the spring-loaded ball 17c, it is possible to suppress the hydraulic pressure in fluid line 37 from varying, thus efficiently suppressing pulse pressure of brake fluid discharged from pump 100. The substantially conically tapered, concave wall surface 372 of check-valve housing chamber 371 serves as a centering means that efficiently centers ball 17c on the opening end of the first discharge line 370a. Thus, it is possible to certainly fully close or shut off the first discharge line 370a by means of the spring-loaded ball 17c.

Referring now to FIG. 9, there is shown the detailed cross-section of check valves 17-18 and gear pump 10 incorporated in the accumulatorless hydraulic brake control system of the first (see FIG. 1), second (see FIG. 5), and fourth (FIG. 7) embodiments. The check valve structure is the same for two check valves 17-18 shown in FIGS. 1, 5, and 7. For the sake of simplicity, the valve structure for only the left-hand side one-way check valve 17 is hereunder explained. Check valve 17 is operably accommodated or housed in a check-valve housing chamber 371, which is defined in the joining portion of pump discharge fluid line 370 and fluid line 37. A part of an inner peripheral wall portion of check-valve housing chamber 371, corresponding to the perimeter of pump discharge fluid line 370, is formed as a substantially conically tapered, concave wall surface 372. Check valve 17 is comprised of a socket 17a, and a ball (a check-valve element) 17c. Socket 17a is comprised of a substantially disk-shaped bottom end portion 170, and a substantially cylindrical portion 171 closed at the left-hand axial end by the bottom end portion 170 and having an opening end communicating pump discharge fluid line 370. Socket 17a having a specified shape and dimensions, in particular, an axial length of the internal space defined in socket 17a, functions to restrict a movement (a movable range) of ball 17c in the internal space of socket 17a. The substantially cylindrical portion 171 of socket 17a is formed with a plurality of radially bored communication holes 172 that intercommunicate fluid line 37 and the internal space of socket 17. The opening end of the substantially cylindrical portion 171 is arranged in such a manner as to surround the perimeter of pump discharge fluid line 370. As can be seen from the cross section of FIG. 9, the outside diameter of ball 17c is dimensioned to be greater than the inside diameter of pump discharge fluid line 370 being substantially circular in lateral cross section, such that ball 17c fully closes the opening end of pump discharge fluid line 370 when the hydraulic pressure in pump discharge fluid line 370 is less than the spring force. The operation of check valve 17 of FIG. 9 is hereunder described in detail.

When motor 50 is rotated and gear pump 10 is driven, a suction stroke and a discharge stroke are alternately repeated at a very short cycle. As is generally known, one complete pumping cycle (suction and discharge strokes) of gear pump 10 is designed to be relatively shorter than that of tandem plunger pump 100. Thus, gear pump 10 is superior to tandem plunger pump 100 in less brake-fluid pulsations (less variations in the discharge amount of working fluid or less pulse pressure). Gear pump 10 is suitable for the continuous stable discharge pressure output. When gear pump 10 is rotating, ball 17c is forced into contact with the bottom end portion 170 of socket 17 by way of brake fluid flow pressurized and discharged from gear pump 10. Thus, during operation of gear pump 10, full fluid communication between pump discharge fluid line 370 and fluid line 37 is maintained. When gear pump 10 is shifted to its stopped state, the hydraulic pressure in pump discharge fluid line 370 falls. The differential pressure between the hydraulic pressure in fluid line 37 and the fallen hydraulic pressure in pump discharge fluid line 370 holds ball 17c at its shutoff position at which pump discharge fluid line 370 is shut off by ball 17c. During a shift of ball 17c to the shutoff position, the conically tapered, concave wall surface 372 of check-valve housing chamber 371 efficiently centers ball 17c on the opening end of pump discharge fluid line 370. Thus, it is possible to certainly fully close or shut off pump discharge fluid line 370 by means of the spring-loaded ball 17c.

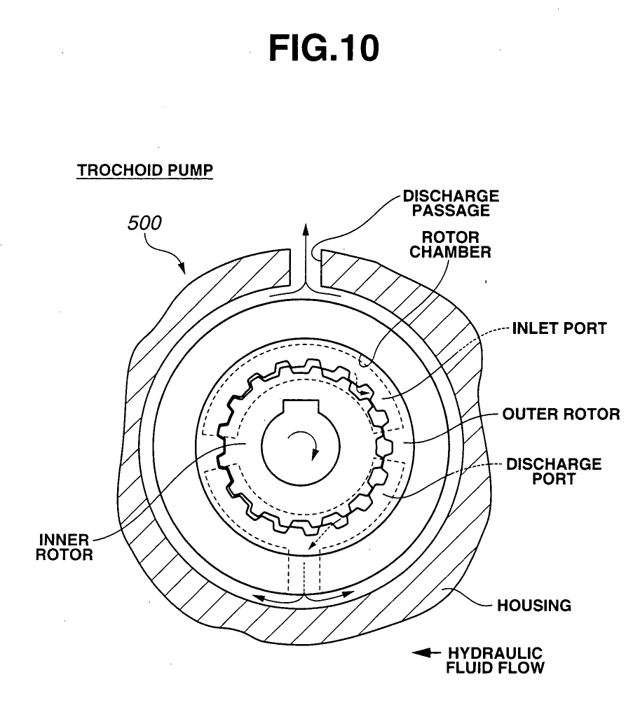

Referring now to FIG. 10, there is shown the detailed pump structure of a trochoid pump (an internal gear pump) 500 applicable to the BBW hydraulic pressure control unit as a hydraulic pressure source for BBW control. The brake control system of each of the shown embodiments may use the trochoid pump (the internal gear pump) as shown in FIG. 10 instead of using an external gear pump or a tandem plunger pump. As shown in FIG. 10, trochoid pump 500 is comprised of an inner rotor having an outer toothed portion and an outer rotor having an inner toothed portion. The outer rotor is rotatably accommodated in a rotor chamber (or a substantially annular working-fluid chamber defined in a pump housing). Inlet and discharge ports are defined in the pump housing. The number Zₒᵤₜ of teeth of the inner toothed portion of the outer rotor is designed or set to the summed value (Zᵢₙ+1) of the number Zᵢₙ of teeth of the outer toothed portion of the inner rotor and “1”. The inner rotor is fixedly connected to the motor shaft of motor 50, such that the inner rotor is driven by motor 50. When motor 50 is rotated and the inner rotor is driven, working fluid (brake fluid) is inducted through the inlet port into a plurality of pump chambers (pumping chambers) defined between the inner toothed portion of the outer rotor and the outer toothed portion of the inner rotor, and then the pressurized working fluid is discharged from the discharge port through a discharge passage of the substantially annular working-fluid chamber into pump discharge fluid line 370. As appreciated, trochoid pump (internal gear pump) 500 having the inner-toothed outer rotor and the outer-toothed inner rotor is a sort of a gear pump. Thus, trochoid pump 500 is superior to tandem plunger pump 100 in less brake-fluid pulsations (less variations in the discharge amount of working fluid or less pulse pressure). Trochoid pump 500 is suitable for the continuous stable discharge pressure output. Additionally, the inner and Outer rotors of trochoid pump 500 are coaxially arranged with each other, thus trochoid pump (internal gear pump) 500 is very compact. The compactly designed trochoid pump 500 is advantageous with respect to smaller layout space requirements of overall system, and reduced system manufacturing costs.

The entire contents of Japanese Patent-Applications Nos. 2005-208046 (filed Jul. 19, 2005) and 2004-268834 (filed Sep. 15, 2004) are incorporated herein by reference.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims.

What is claimed is:

1. A brake control system comprising:
a first fluid pressure source comprising a master cylinder;
a second fluid pressure source provided separately from the master cylinder, for supplying hydraulic pressure from the second fluid pressure source to at least one wheel-brake cylinder during a brake operating mode, the second fluid pressure source comprising a pump;
a manual-brake hydraulic circuit capable of supplying hydraulic pressure from the master cylinder to the wheel-brake cylinder during a fail-safe operating mode;
a pump outlet passage that interconnects the pump and the manual-brake hydraulic circuit, for introducing brake fluid discharged from the pump into the manual-brake hydraulic circuit;
a back-flow prevention device disposed in-the pump outlet passage, for permitting free brake-fluid flow in one direction from the pump to the wheel-brake cylinder and for preventing any brake fluid flow in the opposite direction;
a normally-open inflow valve disposed in the pump outlet passage and located between the back-flow prevention device and the manual-brake hydraulic circuit, for establishing fluid communication between the manual-brake hydraulic circuit and the pump outlet passage with the normally-open inflow valve unactuated and opened; and
a normally-open shutoff valve disposed in the manual-brake hydraulic circuit, for establishing fluid communication between the master cylinder and the wheel-brake cylinder through the manual-brake hydraulic circuit with the normally-open shutoff valve unactuated and opened during the fail-safe operating mode, the normally-open shutoff valve being disposed in the manual-brake hydraulic circuit upstream of the normally-open inflow valve.

2. The brake control system as claimed in claim 1, wherein:
the normally-open inflow valve comprises a normally-open proportional control valve.

3. The brake control system as claimed in claim 2, wherein:
the manual-brake hydraulic circuit comprises a dual circuit brake system having a first manual-brake line and a second manual-brake line laid out independently of each other, the first manual-brake line being connected to a first one of front-left and front-right wheel-brake cylinders, and the second manual-brake line being connected to the second wheel-brake cylinder.

4. The brake control system as claimed in claim 3, wherein:
the back-flow prevention device comprises a check valve that opens when a discharge pressure of brake fluid discharged from the pump exceeds a predetermined pressure value.

5. The brake control system as claimed in claim 4, wherein:
the pump comprises a plunger pump.

6. The brake control system as claimed in claim 5, wherein:
the plunger pump comprises a tandem plunger pump.

7. The brake control system as claimed in claim 4, wherein:
the pump comprises a gear pump.

8. The brake control system as claimed in claim 4, wherein:
the pump comprises a trochoid pump.

9. The brake control system as claimed in claim 3, further comprising:
a hydraulic control module integrating therein at least a brake circuit that intercommunicates the wheel-brake cylinder and the pump and includes at least the pump outlet passage, and the back-flow prevention device as a single hydraulic system block,
wherein a pump discharge port is formed in the hydraulic system block and communicates with the pump outlet passage of the brake circuit, and
wherein the back-flow prevention device comprises a check valve having a valve element and a socket located at the pump discharge port, the socket restricting a movement of the valve element in the free brake-fluid flow direction from the pump discharge port to the wheel-brake cylinder, and the valve element closing the pump discharge port by brake fluid flow from the wheel-brake cylinder to the pump discharge port.

10. The brake control system as claimed in claim 2, wherein:
the manual-brake hydraulic circuit comprises a dual circuit brake system having a first manual-brake line and a second manual-brake line laid out independently of each other, the first manual-brake line being connected to a first pair of wheel-brake cylinders, and the second manual-brake line being connected to a second pair of wheel-brake cylinders.

11. The brake control system as claimed in claim 10, wherein:
the back-flow prevention device comprises a check valve that opens when a discharge pressure of brake fluid discharged from the pump exceeds a predetermined pressure value.

12. The brake control system as claimed in claim 11, wherein:
the pump comprises a plunger pump.

13. The brake control system as claimed in claim 12, wherein:
the plunger pump comprises a tandem plunger pump.

14. The brake control system as claimed in claim 11, wherein;
the pump comprises a gear pump.

15. The brake control system as claimed in claim 11, wherein:
the pump comprises a trochoid pump.

16. The brake control system as claimed in claim 10, further comprising:
a hydraulic control module integrating therein at least a brake circuit that intercommunicates the wheel-brake cylinder and the pump and includes at least the pump outlet passage, and the back-flow prevention device as a single hydraulic system block,
wherein a pump discharge port is formed in the hydraulic system block and communicates with the pump outlet passage of the brake circuit, and
wherein the back-flow prevention device comprises a check valve having a valve element and a socket located at the pump discharge port, the socket restricting a movement of the valve element in the free brake-fluid flow direction from the pump discharge port to the wheel-brake cylinder, and the valve element closing the pump discharge port by brake fluid flow from the wheel-brake cylinder to the pump discharge port.

17. A brake control system comprising:
a first fluid pressure source comprising a master cylinder;
a second fluid pressure source provided separately from the master cylinder, for supplying hydraulic pressure from the second fluid pressure source to at least one wheel-brake cylinder during a brake operating mode, the second fluid pressure source comprising a pump;
a manual-brake hydraulic circuit capable of supplying hydraulic pressure from the master cylinder to the wheel-brake cylinder during a fail-safe operating mode;
a pump outlet passage that interconnects the pump and the manual-brake hydraulic circuit, for introducing brake fluid discharged from the pump into the manual-brake hydraulic circuit;
a normally-closed inflow valve disposed in the pump outlet passage, for blocking fluid communication between the manual-brake hydraulic circuit and the pump outlet passage with the normally-closed inflow valve unactuated and closed; and
a normally-open shutoff valve disposed in the manual-brake hydraulic circuit, for establishing fluid communication between the master cylinder and the wheel-brake cylinder through the manual-brake hydraulic circuit with the normally-open shutoff valve unactuated and opened during the fail-safe operating mode, the normally-open shutoff valve being disposed in the manual-brake hydraulic circuit upstream of the normally-closed inflow valve.

18. The brake control system as claimed in claim 17, wherein:
the manual-brake hydraulic circuit comprises a dual circuit brake system having a first manual-brake line and a second manual-brake line laid out independently of each other, the first manual-brake line being connected to a first one of front-left and front-right wheel-brake cylinders, and the second manual-brake line being connected to the second wheel-brake cylinder.

19. The brake control system as claimed in claim 17, wherein:
the manual-brake hydraulic circuit comprises a dual circuit brake system having a first manual-brake line and a second manual-brake line laid out independently of each other, the first manual-brake line being connected to a first pair of wheel-brake cylinders, and the second manual-brake line being connected to a second pair of wheel-brake cylinders.

20. A brake control system comprising:
a first fluid pressure source comprising a master cylinder;
a second fluid pressure source provided separately from the master cylinder, for supplying hydraulic pressure from the second fluid pressure source to at least one wheel-brake cylinder during a brake operating mode, the second fluid pressure source comprising a pump;
a manual-brake hydraulic circuit capable of supplying hydraulic pressure from the master cylinder to the wheel-brake cylinder during a fail-safe operating mode;
a pump outlet passage that interconnects the pump and the manual-brake hydraulic circuit, for introducing brake fluid discharged from the pump into the manual-brake hydraulic circuit;
back-flow prevention means disposed in the pump outlet passage, for permitting free brake-fluid flow in one direction from the pump to the wheel-brake cylinder and for preventing any brake fluid flow in the opposite direction;
normally-open inflow valve means disposed in the pump outlet passage and located between the back-flow prevention means and the manual-brake hydraulic circuit, for establishing fluid communication between the manual-brake hydraulic circuit and the pump outlet passage with the normally-open inflow valve means unactuated and opened; and
normally-open shutoff valve means disposed in the manual-brake hydraulic circuit, for establishing fluid communication between the master cylinder and the wheel-brake cylinder through the manual-brake hydraulic circuit with the normally-open shutoff valve means unactuated and opened during the fail-safe operating mode, the normally-open shutoff valve means being disposed in the manual-brake hydraulic circuit upstream of the normally-open inflow valve means.
